(19) United States
(12) Patent Application Publication
(10) Pub. No.: US 2022/0335507 A1
(43) Pub. Date: Oct. 20, 2022

(54) SYSTEMS AND METHODS FOR AN INTEGRATED VIDEO CONTENT DISCOVERY, SELLING, AND BUYING PLATFORM

(71) Applicant: Exeest, Inc., New York, NY (US)

(72) Inventor: Matteo Cracco, Brooklyn, NY (US)

(73) Assignee: Exeest, Inc., New York, NY (US)

(21) Appl. No.: 17/722,291

(22) Filed: Apr. 15, 2022

Related U.S. Application Data
(60) Provisional application No. 63/175,990, filed on Apr. 16, 2021.

(51) Int. Cl. G06Q 30/06

(52) U.S. Cl. CPC G06Q 30/0641

(57) ABSTRACT

Systems and methods for global, integrated discovery and connectivity for creators, owners and/or agents of video content (“sellers”), seeking involvement in a licensing or transaction purchasing process for their projects, including but not limited to: films, documentaries, short films, episodic series and television programs, to provide distribution channels, such as digital streaming providers and multimedia network channels (“buyers”). Registered buyers can log in to browse a library of content for which each item displays data provided by the supplier, such as: product features, identification labels, technical details, preferential licenses or terms of sale combined with data acquired from various third-party sources, such as: quality assessment, sales data, usage data, availability data, performance data, also having the possibility to add their degree of interest in the product in order to instruct business intelligence mechanisms that become increasingly accurate in displaying and proposing content relevant to their interest.

### CROSS-REFERENCE TO RELATED APPLICATION(S)

This application claims the benefit of U.S. Provisional Patent Application No. 63/175,990 which was filed on Apr. 16, 2021, all of which is incorporated by reference in its entirety.

### FIELD OF THE INVENTION

The present disclosure relates generally to systems and methods to provide a platform for the uploading, classification, discovery, screening, evaluation, management, licensing, exchange and payment of premium video content involving sellers and buyers. In particular, the present application relates to systems and methods of comprehensive data driven parameters to assist buyers to find digital content to acquire, without the need to physically meet any person or move from their place.

### BACKGROUND OF THE INVENTION

With the rapid growth of video on demand (VOD) services from streaming platforms, media network channels, and over the top (OTT) providers, the market need for content continues to reach new heights. Buyers are in a constant and ever-growing search for new, high quality, and timely content to satisfy the insatiable demand from their customers and audience members. At the same time, the accessibility and affordability of technology to create content has never been greater, thus leading to a boom in content available for purchase or licensing. That said, the system for connecting relevant content buyers and sellers remains wrought with archaic, fragmented, subjective, and exclusive physical barriers that leave the marketplace with inherent flaws, which results in inefficient processes and limitations on transactions, hurting buyers, sellers, and the viewing audience. Inevitably, this flawed state of the industry leads to only a small fraction of all created content being discovered by distributors and enjoyed by consumers. The current inefficiencies in matching buyers and sellers results in fewer transactions, and a lower quality content experience for the end-user customers.

The main problem for sellers is to provide adequate information on content in their catalog to buyers. Catalogs can contain several thousand titles and this information is usually sent to buyers via spreadsheets which is an absolutely inadequate tool to contain all the information the buyer would need to be able to evaluate a purchase. This translates into the fact that buyers tend to always buy the same titles, since they aim for the most popular ones, being in fact almost impossible to be able to carry out a reasoned screening of the eligible contents to be purchased.

For large companies that sell content, it can be problematic to have a very large list of titles to manage. License availability varies continuously and the risk of data mismatches between people working on the same project can be significant.

Another problem for sellers arises when they want to show to buyers unpublished content. In general, for this purpose, platforms such as Vimeo® or YouTube® are used, making the content private and providing the link protected by a password, the same for everyone, to a list of contacts of potential buyers to access. In this way, they strongly expose themselves to the possibility of the content being pirated and published on the black market, since for sellers there is no control over who actually accessed and viewed the content, because the link and the password can be easily and anonymously shared to anyone.

This problem becomes even more relevant at the company level, since it is difficult for sellers to be able to monitor and measure the real interest found by potential buyers on all their content.

The main problem for buyers is to be able to easily find new content to acquire. The aforementioned spreadsheets represent a fragmented system of information necessary to evaluate a purchase. This spreadsheets also represent static information that may already be out of date by the time it is examined. In order to have all the necessary information, buyers are also forced to consult multiple sources: websites, reports, social networks. A long and inefficient process that inevitably leads to being able to consider only a few titles a day and for this to fall back only on the known ones.

Buyers receive invitations to view content from multiple producers on different platforms, resulting in information fragmentation and difficulty in cataloging and discerning content already seen, to be seen, to be considered later or discarded.

### SUMMARY OF THE INVENTION

The present application is directed towards systems and methods for providing a fully integrated premium video content discovery, selling, and buying platform providing one or more of the following functionalities: content submission, discovery through various sorting and filtering tools, organization and rating; content sales, licensing and legal rights management; hosting, billing & payment services; content sharing; a Digital Rights Management (DRM) tool for protecting unauthorized redistribution of content; contract creation and management system that auto-populates deal terms and information already stored in the system and user profiles leading to the ability for buyers to “click to buy” a piece of content without any friction or delay; artificial intelligence/machine learning based system that can forecast user behavior, tastes, and preferences to better understand what they will want to see, license, or acquire and how specific content requirements are evolving or will evolve over a period of time, which can potentially help influence what content creators and production companies should develop.

The combined use of a navigational dashboard, digital library (for discovering content available for sale or licensing), and website (for uploading content to the library, rights management, sale and transaction processing and management, and contract delivery) of the present solution provides an integrated and comprehensive, easy to use and commercially viable, merit-based platform for discovering and trading premium video content.

Optionally, the sellers can choose to pay a fee to have a selected audience evaluate their content, by proposing the project in the streaming platform, in which people willing to receive a fee to view and evaluate content are registered.

The “streaming platform” option is very useful for producers of content not yet released, who want to have a rating on their digital content with which they can arouse the interest of buyers who will be able to freely access the digital content through a dedicated library. In this way, buyers will be able to focus only on projects that have received interest from the audience, in fact drastically reducing the screening time necessary for them to evaluate new projects.

According to one or more embodiments of the invention, a method of providing private access to digital content stored within a digital web-based platform comprises: providing a digital web-based platform, the digital web-based platform is configured to store digital content which is accessible to one or more users; uploading, with a computing device of a first user, digital content to the digital web-based platform; and generating, with the computing device of the first user, a link for accessing the digital content stored within the digital web-based platform. The link includes a set of user permissions that grants viewing access to the digital content until at least one of: a predetermined time interval expires and a predetermined number of views is reached. The method further comprises: transmitting, with the computing device of the first user, the link to a computing device of a second user; displaying, with an interface of the computing device of the second user, the link to the second user; and wherein engaging the link directs the second user to the stored digital content. The second user is able to view the digital content until at least one of: the predetermined time interval expires and the predetermined number of views of the digital content is reached.

In one aspect, the stored digital content includes one or more media projects.

In another aspect, the digital web-based platform is hosted by a central computing device in wireless communication with the computing device of the first user and the computing device of the second user.

In another aspect, the central computing device is associated with a third user different from the first and second users.

In another aspect, the computing devices of the first and second users are each one of a mobile device, tablet, laptop, or computer.

In another aspect, at least one of the central computing device, the computing device of the first user, and the computing device of the second user includes processing circuitry. The processing circuitry having a processor and memory in communication with the processor.

In another aspect, the method further includes providing a second platform that is in communication with the first platform; generating, with the computing device of the first user, a link for accessing the second platform; and transmitting the link for accessing the second platform to a computing device of a third user so that the third user can stream the stored digital content from the digital web-based platform.

In another aspect, the central computing device is configured to receive a signal from the computing device of the second user to disable the link.

According to one or more embodiments, a method for assigning a payment level to one or more users reviewing digital content comprises: providing, with a central computing device, a first platform and a second platform in communication with the first platform; uploading, from a computing device of first user, digital content to a content library of the first platform; storing the digital content within the content library, the digital content being accessible to one or more secondary users via streaming from the second platform when in the content library; assigning, with the central computing device, the digital content to a first content category for a predetermined time period, the digital content being assigned a first payment level when in the first content category; and measuring and comparing, with the central computing device, a number of secondary users streaming the digital content via the second platform to a predetermined threshold.

In another aspect, the predetermined threshold is a maximum of number of views allowed for the digital content.

In another aspect, the method further includes transferring the digital content to a second content category if the predetermined threshold is reached within the predetermined time period. The digital content is assigned a second payment level when in the second content category. The second payment level is less than the first payment level.

In another aspect, the method further includes transferring the digital content to a third content category if the predetermined threshold is not met within the predetermined time period. The digital content is assigned a third payment level when in the third content category. The third payment level is greater than the first payment level.

In another aspect, the method further includes measuring and comparing a number of secondary users viewing the digital content in the third category to the predetermined threshold.

In another aspect, the method further includes transferring the digital content to a fourth category if the predetermined threshold is not met within a second predetermined time period. The digital content is assigned a fourth payment level when in the fourth content category. The fourth payment level is greater than the third payment level.

In another aspect, the central computing device is configured to receive qualitative feedback from a user computing device associated with each of the one or more secondary users.

In another aspect, the qualitative feedback includes at least one of a user generated numerical score and written feedback.

In another aspect, the content library is accessible to a third user different from the first user and the one or more secondary users.

In another aspect, the one or more secondary users and the third user each have a computing device configured to be in communication with the central computing device so that each user can access at least one of the first platform and the second platform.

In another aspect, the method further includes generating an invitation link to access the stored digital content and providing the invitation link to the third user to access the stored digital content.

According to one or more embodiments, a digital web-based platform system comprises a central computing device having processing circuitry configured to host a first platform and a second platform in communication with the first platform; a plurality of user computing devices, at least one of the plurality of user computing devices is in communication with the first platform via a web-based connection and at least one of the plurality of user computing devices being in communication with the second platform; and at least one other computing device being in communication with the first platform via an Application Programming Interface (API) connection. The first platform includes one or more microservices each associated with a predetermined system operation. The second platform includes a content library configured to store digital content uploaded from at least one of the plurality of user computing devices for streaming to another user computing device. The first platform and the second platform each utilize the processing circuitry of the central computing device to store digital content uploaded by a user.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features, and advantages of the present disclosure will become apparent from the following detailed description taken in conjunction with the accompanying Figure showing illustrative embodiments of the present disclosure.

FIG. 1 depicts a block diagram of an exemplary platform for providing the systems and methods described herein;

FIG. 1A depicts a block diagram of the “life cycle” of the content and the system integrating between buyers and sellers;

FIG. 2 depicts a block diagram of a central computing device in accordance with the principles of the present invention;

FIG. 3 depicts a block diagram of a user computing device in accordance with the principles of the present invention;

FIGS. 4-4A depict a block diagram of the server-side microservice components of the platform of FIG. 1;

FIGS. 5-5A depict an exemplary title submission page. The User can start submitting a new project on the platform by selecting its format, type and status, and by entering the title. If the title already exists in the exemplary platform's database, the data can be automatically entered into the submission form. Otherwise, the User can manually add all the information;

FIGS. 6-8 depict exemplary submission form pages. The submission form is where the sellers can upload their content by entering all the data and information about their titles;

FIG. 9 depicts an exemplary import catalogue page. This feature gives the opportunity to the seller User to create multiple drafts simultaneously by uploading a .CSV file;

FIG. 10 depicts an exemplary draft page. This is the page where the User can access all his ongoing Drafts;

FIGS. 10A-10C depict exemplary pages associated with draft pages. Through this section the User can see all the drafts that have been paid and uploaded on the platform, as well as their quality range;

FIGS. 11-11A depict an exemplary dashboard page, which can depict an overview of the Company's analytics. Through this page the seller can easily check the ongoing of the content or trailer views, page visits, percentage of content watched, offers received, etc.;

FIGS. 12-13A depict exemplary screener pages. The seller User has the possibility to share their projects through a link that can automatically be generated by the platform. The seller can add privacy and security settings to this link, such as a password to access it or an expiration date;

FIGS. 14, 14A, and 15 depict exemplary screening room pages. Instead of sharing one title, the screening room gives the User the possibility to share more projects through the same link. A Room needs to be populated at least with three titles;

FIGS. 16, 16A, and 16B depict an exemplary company panel. Every company can manage its members and activities through the Company Panel. They can add new members and choose their role depending on the authorizations they want them to have;

FIGS. 17-17A depict an exemplary content page, which is the result of the Submission Form. The User will be able to see all the data and media they entered about their title; Moreover, they can have a preview of what buyers will see about their projects. This page is accessible by clicking on the title's poster in the Projects page or on the “Content Page” button next to the Projects title;

FIG. 18 depicts an exemplary main page of the guest platform, where the User can view all the screeners they received by the sellers;

FIGS. 19-19A depict an exemplary home page of the buyer platform where the User can browse around all the content uploaded by the sellers;

FIGS. 20-20A depict an exemplary page where the user can view all the data, information and media about the project, including the main content (full length video);

FIG. 21 depicts an exemplary method for calculating audience member payment levels;

FIG. 22 depicts a block diagram of seller processes associated with the exemplary platform in accordance with the principles of the present invention;

FIG. 23 depicts a block diagram of buyer processes associated with the exemplary platform in accordance with the principles of the present invention;

FIG. 24 depicts a block diagram of White Label user processes associated with the exemplary platform in accordance with the principles of the present invention;

FIG. 25 depicts a block diagram of audience member processes associated with the exemplary platform and a streamlining platform in accordance with the principles of the present invention; and

FIG. 26 depicts a block diagram of Transactional Client Company processes associated with the exemplary platform in accordance with the principles of the present invention.

### DETAILED DESCRIPTION

Detailed embodiments are disclosed herein; however, it is to be understood that the disclosed embodiments are merely illustrative of systems and methods for distributing media content that may be embodied in various forms. In addition, each of the examples given in connection with the various embodiments of is intended to be illustrative, and not restrictive. Further, the drawings and photographs are not necessarily to scale, and some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ systems and methods for distributing media content.

A description herein of one or more embodiments of the invention may refer to a platform application, or multiple platform applications, that are maintained by central computing device. The term “computing device” may be used herein to refer to any such device, which may be capable of sending and receiving information, e.g., wirelessly via one or more voice and/or data networks or through a wired network. For brevity, an application (such as, e.g., a software application) for use on a computing device may be referred to herein as an “application.”

It will be appreciated that an application, operating on one or more computing devices (discussed in more detail below) to process information, may use hardware and/or software of the computing device to cause information to be transmitted from the computing device. Similarly, information may be received by the computing device and made available to an application by one or more facilities provided by the hardware and/or software of the computing device. For brevity, such operations may be referred to simply as transmission and reception of information, respectively, by the application.

Embodiments in accordance with the principles of the invention may be practiced in connection with one or more programmable computing devices such as, for example, a digital computer, making up a digital media content system 10. The system 10 includes at least one central computing device and/or user computing device having at least one processor, coupled to a communications channel. The computer system 10 further includes at least one input device such as, e.g., a keyboard, at least one output device such as, e.g., an LCD display, a communications interface, a data storage device, which may comprise, e.g., a magnetic disk, an optical disk, and/or another non-transitory computer-readable storage medium, each coupled to the communications channel. The communications interface may be coupled to a network such as the Internet. In some embodiments, the at least one input device and/or the at least one output device may be integrated with the computing device.

The data storage device of any given computing device may store instructions executable by one or more processors or kinds of processors, data, or both, which may represent, e.g., one or more operating systems, programs, and/or other functions and/or data.

As described herein, it should be understood that the terms “user” or “users” may generally refer to one or more sellers, buyers, audience members, guests, vendor, rights management data companies, and/or third-party data companies.

As described herein, it should be understood that the term “sellers” also includes content creators who develop and create digital content to upload to the platform 12, and individuals or entities owning the rights to a digital work or project.

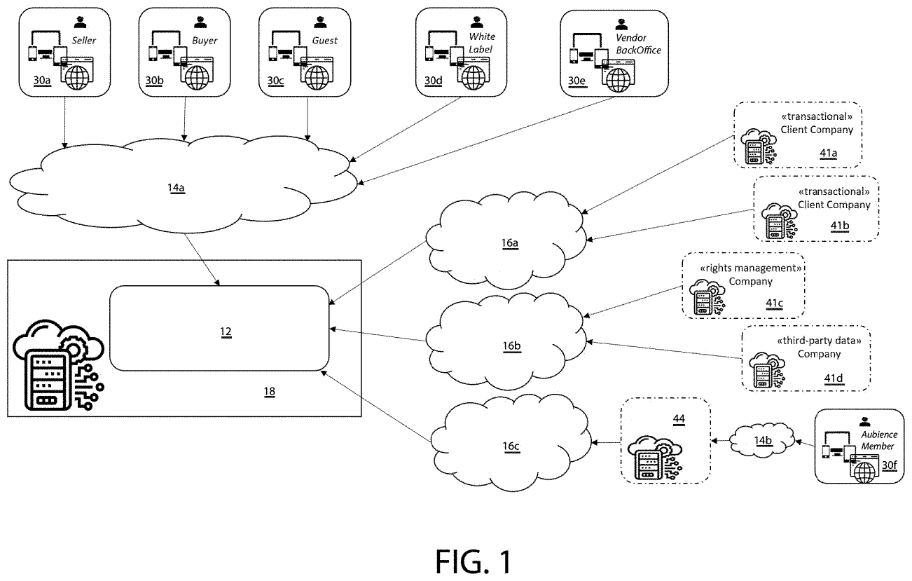

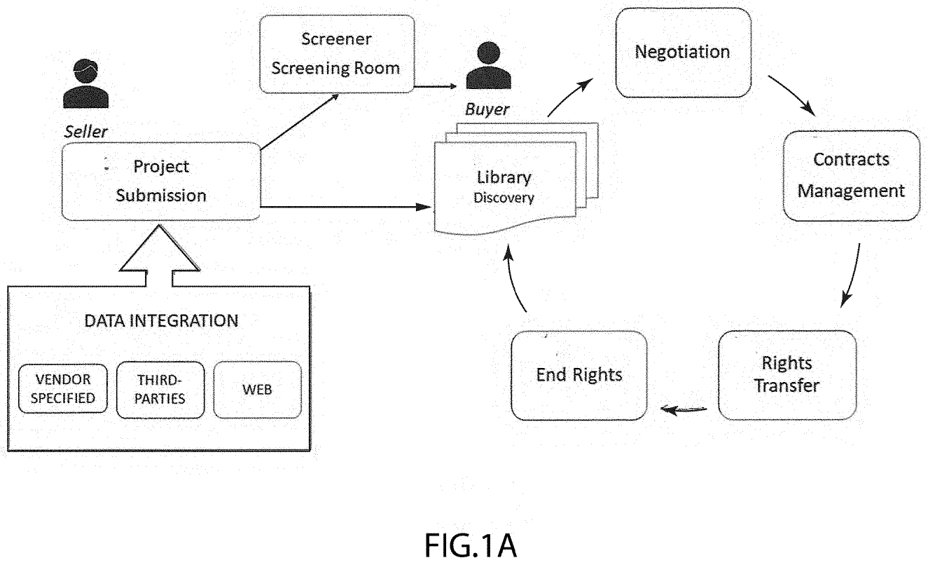

Now referring to FIG. 1, a block diagram of an exemplary digital media content system 10 is shown. The system 10 uses an exemplary digital web-based platform 12 that may be in communication with one or more users. As discussed in more detail below, the platform 12 that is registered to a web cluster and implemented by a central computing device of a vendor and provides the systems and methods described herein. The platform 12 described herein is available anytime to buyers and sellers Worldwide such that there are no restrictions on when buyers or sellers from around the world can access the exemplary platform 12 to upload content for sale, or seek content to purchase or license the desired media projects.

As shown in FIG. 1, each of the users is in communication with the platform 12 via one or more web-based connections 14 (e.g., internet client-to-server browser connections). Each user has a respective computing device (discussed in more detail below) that is programmed and/or configured to enable each user to communication with content and other users associated with the platform 12. In other words, users of the platform 12 may use their computing devices to interact with digital content (e.g., digital media content, media projects, titled works, etc.) uploaded and stored within the platform 12, and interact with other users who have access to the same platform. In some embodiments, users such as rights management data companies, transactional client companies, and third-party data companies are in communication with the platform 12 via server-to-server internet API connections 16a-n.

Continuing to FIG. 1, according to one or more embodiments, partner companies (e.g., white label partner companies) of a vendor can be in communication with the platform 12 via their user computing device (e.g., user computing devices 30a-f discussed below) which is configured to access the platform 12 through the web-based connection 14a. The partner company can display on their website, using inline frame (iFrame) technology that connects to vendor servers, all or part of their project catalog, previously imported on the platform 12. The project catalog is a listing of all of the partner company's digital content/projects that have been imported to the platform 12. Each partner company has the ability to customize which projects to visualize in the catalog and in what order, highlighting the ones the partner company wants to put in evidence. In this way, by managing a single upload, the partner company can have their projects presented on both the platform 12 and the partner company's website to have greater visibility and the possibility to attract prospective buyers. Partner companies also have a specific information panel viewable within the platform 12 where they have the opportunity to look at online statistics or download detailed reports on the engagement that each project has had in a given time frame.

It should be understood that iFrame technology is an HTML element that allows an external webpage to be embedded in an HTML document. unlike traditional frames, which were used to create the structure of a webpage, iFrames can be inserted anywhere within a webpage layout.

Continuing to refer to FIG. 1, it is to be understood that according to one or more embodiments, the central computing device and/or user computing devices may be configured to enable companies such as, for example, transactional client companies, rights management companies, and third-party data companies to do the following: purchase their own platforms through transactional API's 16a-n; integrate key digital transactional functionality (in part or as a whole) developed by the vendor into the platform 12, including the sales of rights and licenses; manage the negotiation of offers to purchase or license a project; use the “buy-now” button (or other similar button) to purchase a project; automatically generate contracts and the subsequent phases of review and signature; act as fiduciary of payments with the escrow mechanism; and manage deliverables as per contractual obligations. Although not described in detail herein, it should be understood that all third-party data companies, rights management data companies, and transactional client companies can access the platform 12 through the use of a third computing device such as company computing devices 41a-n.

FIG. 1A depicts a block diagram of the “life cycle” of the content and the system integrating between buyers and sellers. As shown in FIG. 1A, the central computing device 18 is also configured to create a customizable library within the exemplary platform 12 of curated content titles available for licensing or acquisition. The library can be sorted and filtered (using the CQRS system discussed above) based on a number of variables such as genre, sub-genre, price, year created, rating, cast, crew, director, “tags” (as provided by the seller in the submission form) like language, territory, date of upload, type of license/rights, windows, filming location, etc. All settings and filters can be saved to the users profile so that each time they login, they can automatically see the library that is most relevant to the types of films that they are most interested in licensing or acquiring. Buyers can even set up and save multiple filter settings so that they can switch easily.

Buyers can indicate the films they are not interested in by using a designated button that is presented to them on the platform 12. For example, the button may be a “Don't show me this again” button or the like and also allows buyers to specify the reason for their choice (“I am not interested in . . . ”: this title, this actor, this director, this genre) in a linked note, so that the system overshadows them in the main screen. Likewise they can remove a movie from the “Keep watching” section, as they are not interested in continuing to watch it. buyers can indicate a rating to the content and add personal notes, these data remain private for the user and are not shared. In this way they will be able to sort the contents of the library according to their personal rating and also use the search engine to search for keywords in their personal notes.

Bidding Mechanism for the acquisition of licenses—The buyer who is interested in purchasing a license to use can do so in a very short time using the “Buy Now” button, with which he accepts the proposed price, which may have been set manually by the seller, or calculated independently by the platform 12. If, on the other hand, the Buyer wants to propose a different purchase price, they can do so and the Seller will be notified. In case of a deadlock in the negotiation, an agent or representative of the vendor can intervene to contact the parties and find a mediation.

Comprehensive Purchase System—buyers may elect to purchase or license content at the presented “buy now” price, initially set by the Seller as the ideal terms they are looking to achieve. This could allow a Buyer to acquire the content immediately. Alternatively, the Buyer could offer or “bid” a different price that they would prefer. In this case, other potential Buyers could enter their own “bid” as multiple Buyers vie for the same opportunity. This process could help the Seller achieve greater visibility across more Buyers and a higher value for their content.

Business Intelligence for buyers—To provide a Recommendation Service to buyers, all data relating to the explicit and implicit behavior of the user can be stored in the memory 26 of the central computing device 18. Analyzing the buyer type user, by way of example, the explicit behaviors are: like, save as favorites or in the watchlist, click on “I don't care”, assign a rating to the content, search for a specific genre, actor, director, type of license, etc.

The implicit behaviors are all those that highlight everything that the user does, but also doesn't do, with the content. The exemplary platform 12 can therefore register/store in the exemplary system's 10 database all the posters that the exemplary platform 12 can show to the user, and for each of them how many times the exemplary platform 12 can show it, to establish how many views are necessary to make the user interact with the content and also what is the threshold beyond which to start showing him the content in an increasingly sporadic way, until it “disappears” (unless explicitly searched for). Everything you click, which is followed by an in-depth action or not. In a usual scenario, which leads from the identification of a film to the purchase of the license, the exemplary platform 12 can have an escalation of this type of behavior, with the User who: displays the poster, hover of the mouse on the poster to view additional information, click on the poster to examine in detail the info written on the dedicated page of the content, click on the trailer, click on the film, click to contact the seller, possible purchase proposal, finalization of the purchase.

In this flow, the user can, at any time and using their computing device 30, click on: add to the watchlist, assign his ILR (Interest Level Rate), set a reminder, add to favorites. If he interrupts the flow, it can mean that what he saw/analyzed made him lose interest in the content. So the exemplary platform's matching system can assign different scores according to the various combinations of behaviors.

Sales Contracts and Content Rights Generation—A seller may provide terms within the exemplary platform 12, via their user computing device 30, that the buyer wishes to achieve upon the purchase or licensing of a piece of a media project. This information, along with the details provided by the Seller upon submission of the media project, is used by the central computing device 18 to automatically generate a legal agreement using prepared contract templates stored in the platform 12 as a base, with interchangeable standard legal language for various electable buyer scenarios. Upon a deal or offer, a copy may then be automatically sent immediately to all parties involved with the agreement, such as a buyer, seller, and a representative of the vendor who then helps finalize the deal and payment terms. A preview of the agreement can also be generated as a PDF preview by the central computing device 18 and/or user computing device 30 while the buyer is interacting with specific elements they are interested in having included in the agreement like subtitles, territory, length of license, etc.

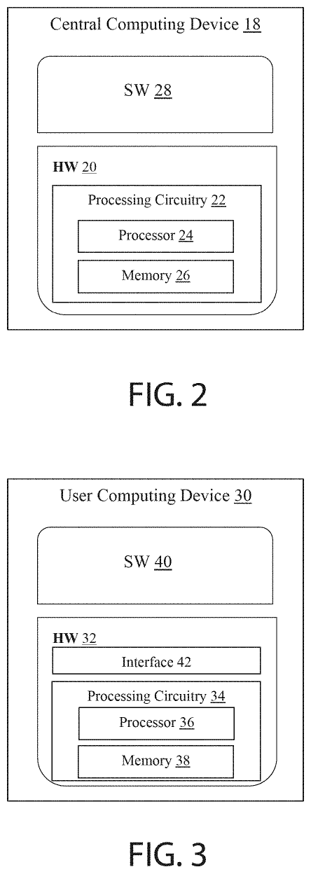

FIG. 2 shows an exemplary central computing device 18 in accordance with the principles of the present invention. The central computing device 18 is configured and/or programmed to implement the platform 12. In one or more embodiments, the central computing device is configured to include hardware (HW) 20. The hardware 20 may include processing circuitry 22, which may include a processor 24 and a memory 26. In particular, in addition to or instead of a processor 24 such as a central processing unit and memory, the processing circuitry 22 may include integrated circuitry for processing and/or control, e.g., one or more processors and/or processor cores and/or FPGAs (Field Programmable Gate Array) and/or ASIC's (Application Specified Integrated Circuitry) adapted to execute instructions. The processor 24 may be configured to access (e.g., write to and/or read from) the memory 26, which may comprise any kind of volatile and/or nonvolatile memory, e.g., cache and/or buffer memory and/or RAM (Random Access Memory) and/or ROM (Read-Only Memory) and/or optical memory and/or EPRO (Erasable Programmable Read-Only Memory). Further, the memory 26 may be configured as a storage device.

The central computing device 18 is also configured to include software (SW) 28. The software 28 is stored internally in, for example, the memory 26, or stored in external memory (e.g., database, storage array, network storage device, etc.) and may be accessible by the central computing device 18 via an external connection. The software 28 may be executable by the processing circuitry 22.

The processing circuitry 22 may be configured to control any of the methods and/or processes described herein and/or to cause such methods, and/or processes to be performed, e.g., by the central computing device 18. The processor 24 corresponds to one or more processors for performing central computing device 18 functions described herein. In some embodiments, the software 28 may include instructions that, when executed by the processor and/or processing circuitry, causes the processor 24 and/or processing circuitry 22 to perform the processes described herein with respect to the central computing device 18.

FIG. 3 shows an exemplary user computing device that is representative of computing devices 30a-f which are referred to collectively user computing device “30”. Each user computing device 30 may be associated with a different user and is in communication with the central computing device 18. For example, the computing device 30 of each user may be a mobile device, laptop, computer, tablet/iPAD®, etc.) configured and/or programmed to allow each user to communicate and interact with the platform 12 through the use of a web-based connection. In one or more embodiments, the user computing device 30 is configured to include hardware 32. The hardware 32 may include processing circuitry 34, which may include a processor 36 and a memory 38. In particular, in addition to or instead of a processor 36 such as a central processing unit and memory, the processing circuitry 34 may include integrated circuitry for processing and/or control, e.g., one or more processors and/or processor cores and/or FPGAs (Field Programmable Gate Array) and/or ASIC's (Application Specified Integrated Circuitry) adapted to execute instructions. The processor 36 may be configured to access (e.g., write to and/or read from) the memory 38, which may comprise any kind of volatile and/or nonvolatile memory, e.g., cache and/or buffer memory and/or RAM (Random Access Memory) and/or ROM (Read-Only Memory) and/or optical memory and/or EPRO (Erasable Programmable Read-Only Memory). Further, the memory 38 may be configured as a storage device.

The user computing device 30 is also configured to include software (SW) 40. The software 40 is stored internally in, for example, the memory 38, or stored in external memory (e.g., database, storage array, network storage device, etc.) and may be accessible by the user computing device 30 via an external connection. The software 40 may be executable by the processing circuitry 34.

The processing circuitry 34 may be configured to control any of the methods and/or processes described herein and/or to cause such methods, and/or processes to be performed, e.g., by the user computing device 30. The processor 36 corresponds to one or more processors for performing user computing device 30 functions described herein. In some embodiments, the software 40 may include instructions that, when executed by the processor and/or processing circuitry, causes the processor 36 and/or processing circuitry 34 to perform the processes described herein with respect to the user computing device 30.

Further, each user computing device 30 may include an interface 42 such as a monitor, touchscreen display, or other type of display that allows users to visualize the platform 12, panel data associated w and the graphical user interface associated with the platform 12.

It should be understood that according to one or more embodiments, each company computing device is configured to include hardware and software as described above with respect to the central computing device 18, and is configured to perform the operations and functions necessary to allow the Companies to communicate with the platform 12 via API connections 16a-c.

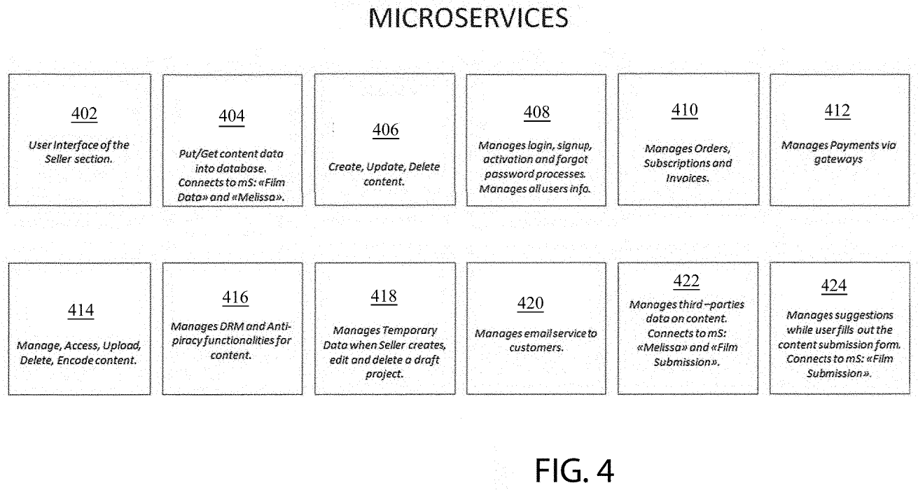

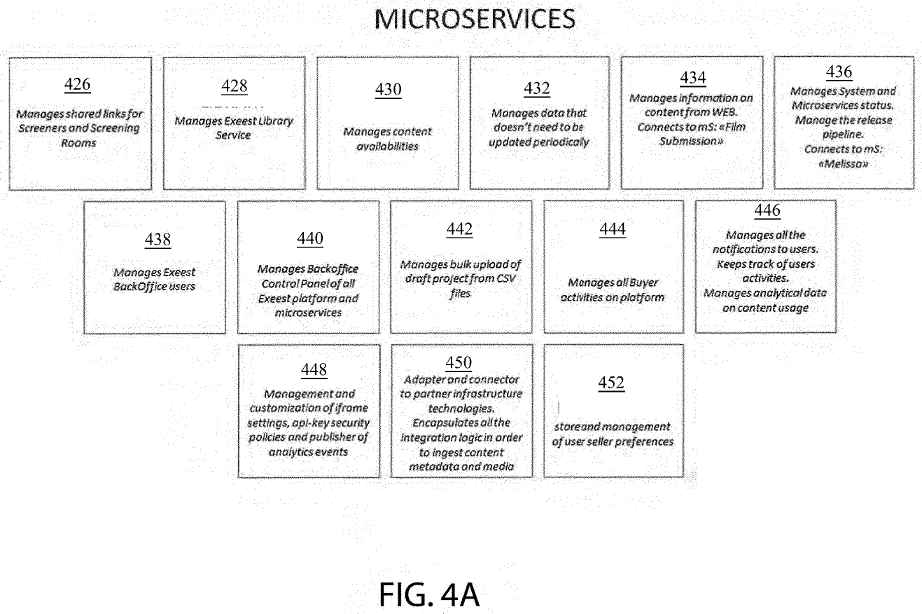

FIGS. 4-4A depicts a block diagram of the server-side components (microservices) of the platform 12. According to one or more embodiments, the exemplary platform 12 can be implemented by the central computing device 18, which is capable of sending and receiving information, e.g., wirelessly via one or more voice and/or data networks or through a wired network to each user computing device 30 that is in communication with the central computing device 18. The exemplary platform 12 may include a microservices architecture, which can be comprised of a number of different microservices, as depicted in FIGS. 1, 4, and 4A. As described herein, a microservice is a server application responsible for managing a type of relevant data in the business domain. It manages its life cycle and implements the interfaces of its operations. In the present system 10, each microservice is released within containers, which are orchestrated through open-source system technologies for automatic deployment, scaling, and management of containerized applications, within a cluster of nodes made available by a cloud service provider.

For example, in one or more embodiments (as shown in FIGS. 4-4A), the platform 12 may be programmed and/or configured to include the following variety of microservices (MS):
MS 402: User interface of the seller section;
MS 404: Put/Get content data into database. Connects to MS 422 and MS 440;
MS 406: Create, update, and delete content;
MS 408: Manages login, signup, activation and forgot password processes. Manages all user information;
MS 410: Manages orders, subscriptions, and invoices;
MS 412: Manages payments via gateways;
MS 414: Manage, access, upload, delete, encode content;
MS 416: Manages DRM and Anti-piracy functionalities for content;
MS 418: Manages temporary data when seller creates, edit, and deletes a draft project;
MS 420: Manages email service to customers;
MS 422: Manages third-parties data on content. Connects to MS 400 and MS 404;
MS 424: Manages suggestions while a user fills out the content submission form. Connects to MS 404;
MS 426: Manages shared links for screeners and screening rooms;
MS 428: Manages vendor digital library service;
MS 430: Manages content availabilities;
MS 432: Manages data that does not need to be updated periodically;
MS 434: Manages information on content from WEB. Connects to Film Submissions microservice;
MS 436: Manages system and microservices status. Manages the release pipeline. Connects to MS 440;
MS 438: Manages vendor backoffice users;
MS 440: Manages backoffice control panel of all vendor platform and microservices;
MS 442: Manages bulk upload of draft project from CSV files;
MS 444: Manages all buyer activities on platform;
MS 446: Manages all the notification to users. Keeps track of users activities. Manages analytical data on content usage;
MS 448: Management and customization of iFrame settings, api-key security policies and publisher of analytic events;
MS 450: Adapter and connector to partner infrastructure technologies. Encapsulates all the integration logic in order to ingest content metadata and media; and
MS 452: Store and management of user seller preferences.

User Generated Content Search—The exemplary platform 12 is configured to provide a Command and Query Responsibility Segregation (CQRS) architectural system that allows the digital library to record the data of each microservice that may be interesting to show to a buyer by making queries only for what the buyer needs and filtering the contents. In other words, the platform 12 may provide search and filter functionality. Keywords including the genre, sub-genre, price, date uploaded, rating, availability and “tags” may be applied by the seller during the submission upload process. Using the search features to call upon these keywords and “tags” may help buyers find higher quality matches based on their preferred content criteria.

System Generated Content Recommendations—The exemplary platform 12 uses algorithms and artificial intelligence/machine learning to recommend content to a buyer based on the information the buyer provides in their user profile as well as their level of engagement with certain elements of the platform or types of content. For example, if a buyer saves several horror films to check out in more detail later, or watches multiple trailers for horror films, the platform 12 may automatically recommend other horror films that express similar features or criteria. It should be understood that the necessary functions and/or operations performed to prepare the recommendation to the buyer are executed by the central computing device 18 and stored within memory 26, which may be accessed by a buyer's user computing device 30.

According to one or more embodiments, based on the preferences entered by the buyer when they signup to for the platform 12, the central computing device 18 searches for content that has data matching the greatest number of features (e.g. Anime genre, Asia territory, SVOD) that match the buyer's preferences. The buyer first displays content that matches all requirements, then one less, and so on.

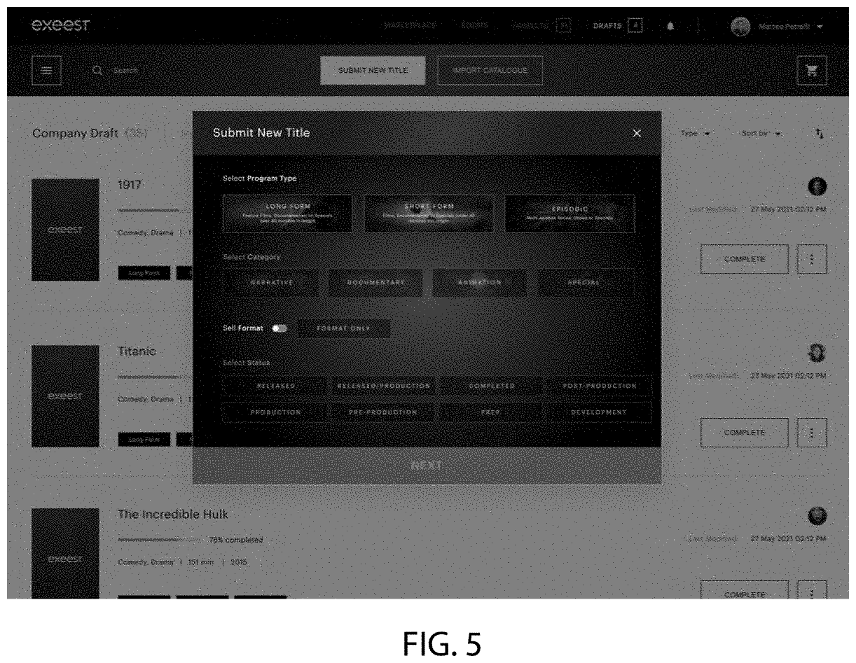

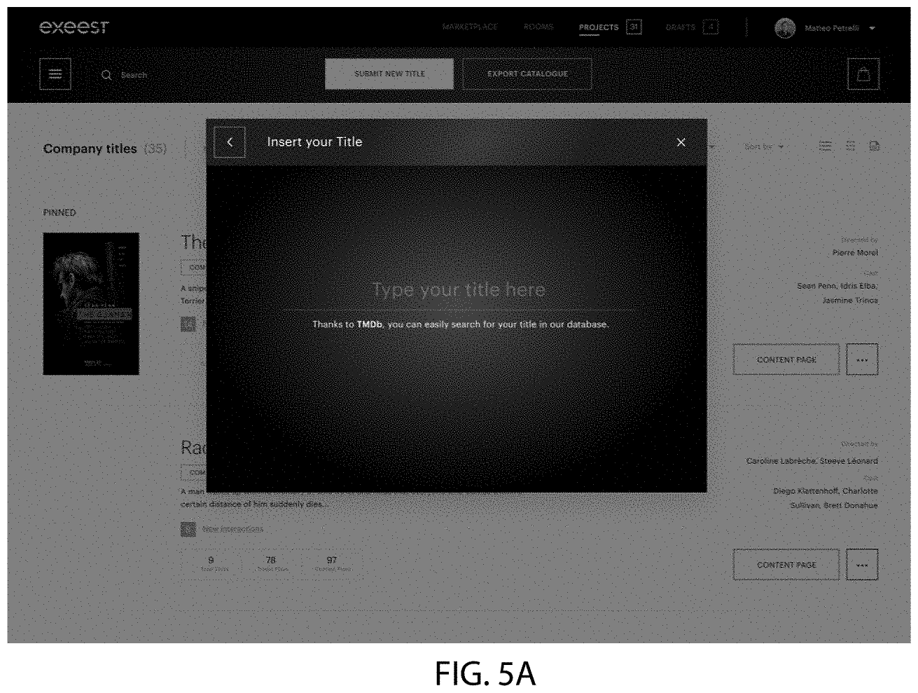

FIGS. 5-5A depicts an exemplary title submission page. Sellers can start submitting new digital content on the platform 12 by selecting its format, type and status, and by entering the title of the digital content. If the title of the digital content already exists in the exemplary platform's 12 database, the data can be automatically entered into, or populated within, the submission form. Otherwise, the users can manually add all the information via an input device of the user computing device 30.

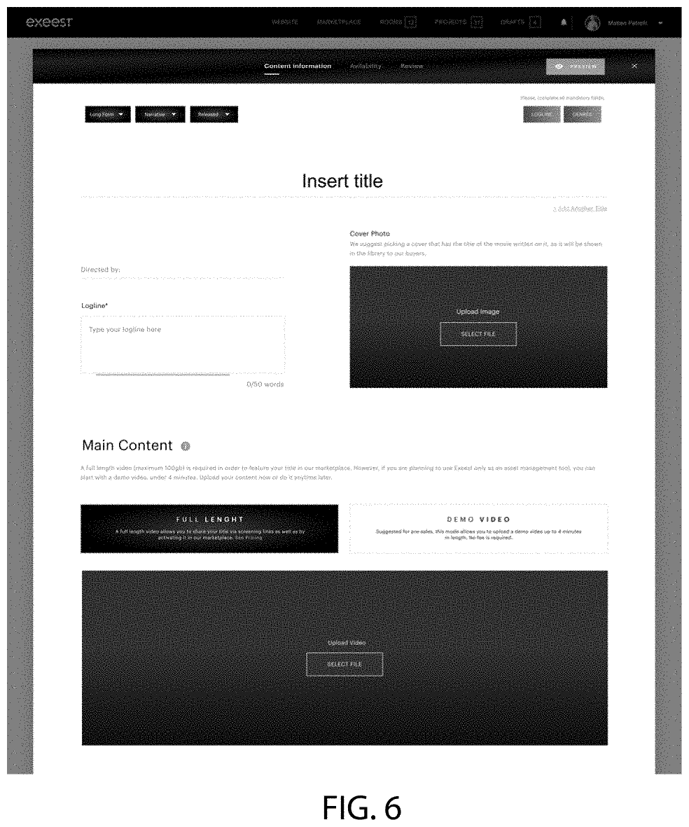

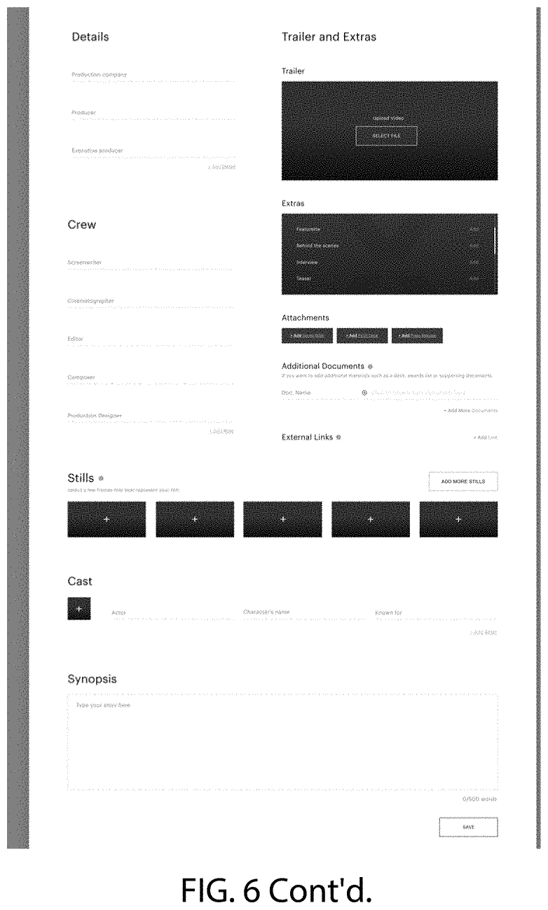

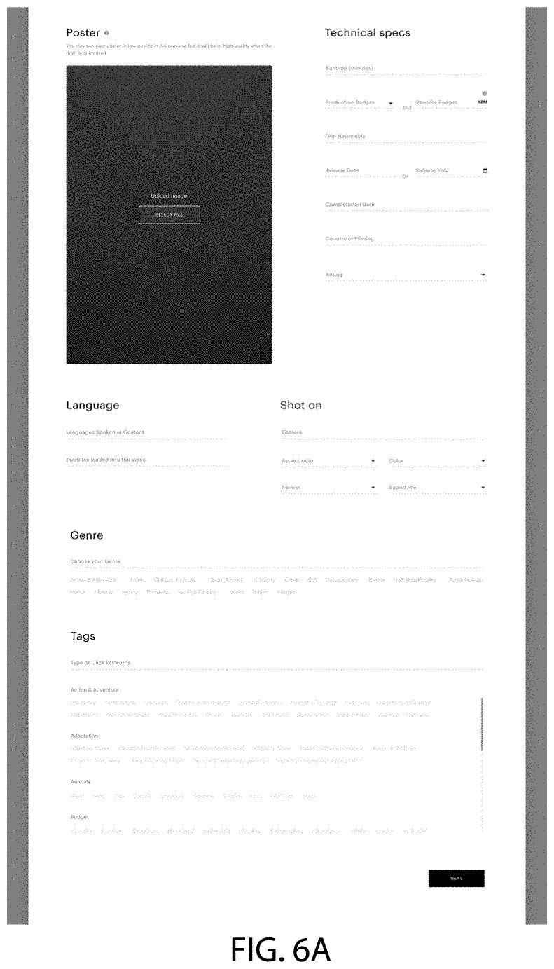

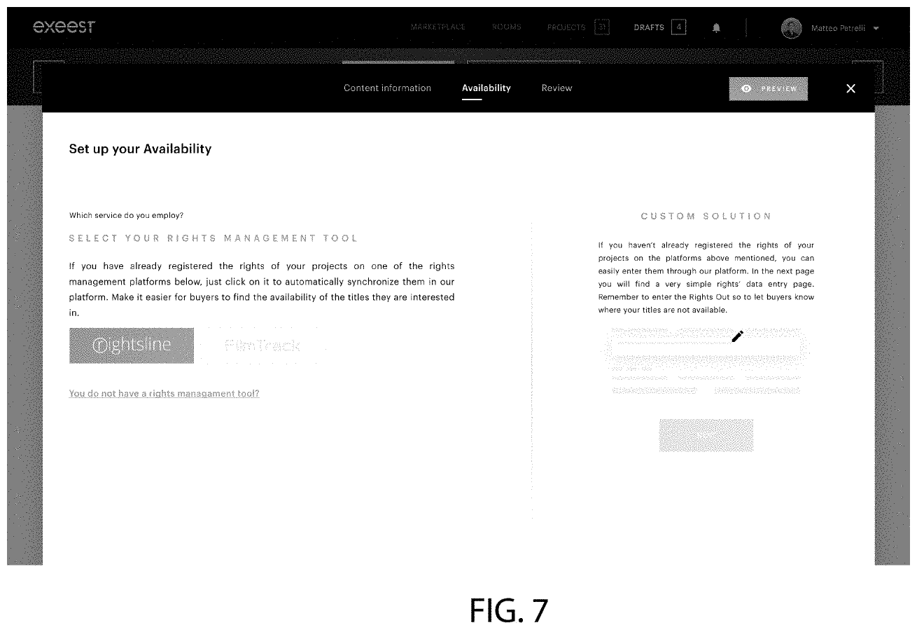

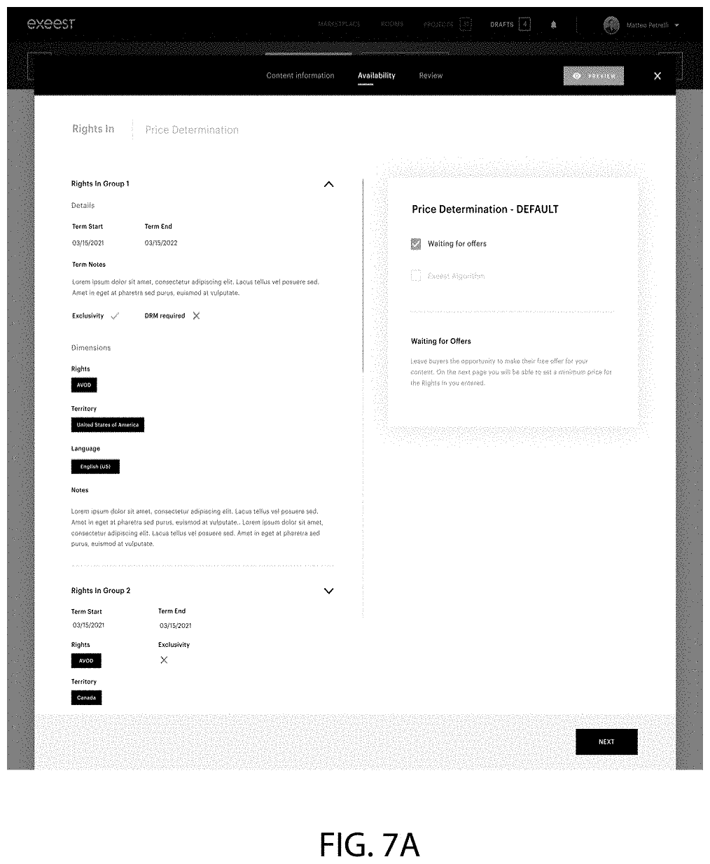

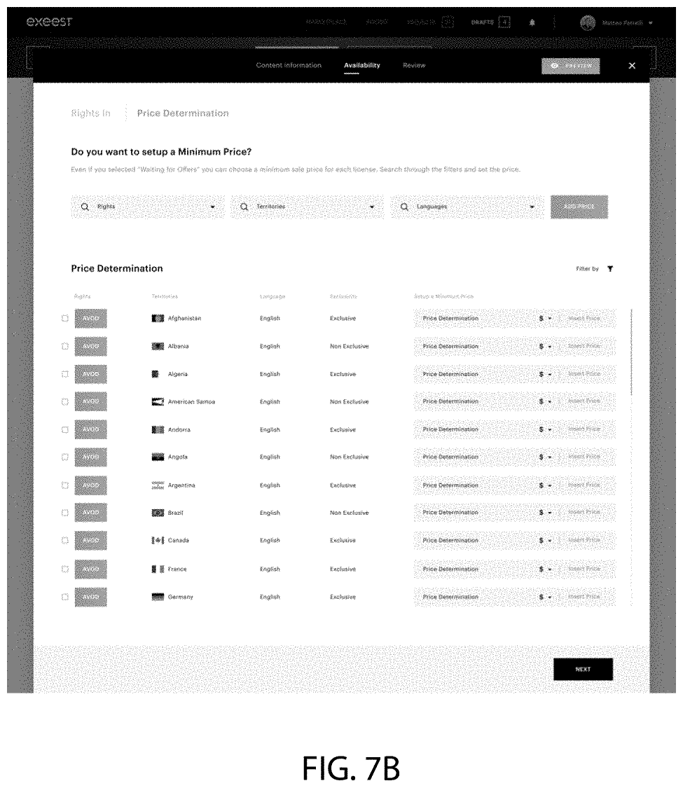

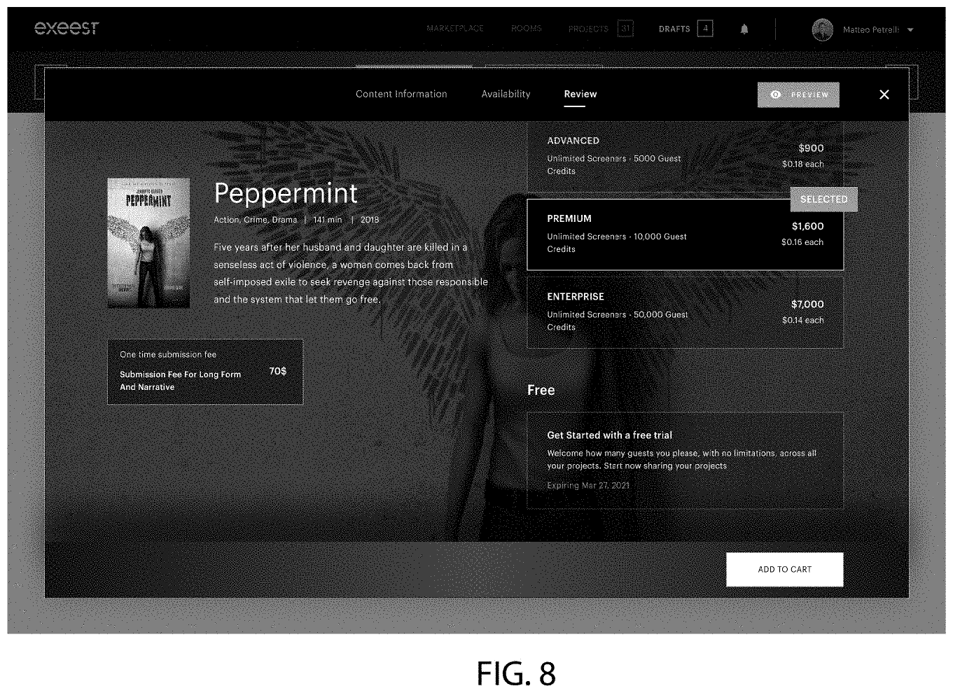

FIGS. 6-8 depict exemplary submission form pages presented to sellers when uploading digital content to the platform 12. The submission form is where the sellers can upload their content by entering all the data and information about their titles.

Non-Restricted seller Content Submission—All sellers, regardless of experience, entertainment industry relationships, formal agency representation, or geography may upload, from anywhere, at any time, various types of digital content (i.e., which includes media projects) to the exemplary platform 12 via their respective computing device 30, such as feature films, documentaries, short films, and episodic series, shows and animation, through an online submission form which requests the following information: project title, log line and brief synopsis, preferred licensing, sale terms, pricing and deal and ownership or chain of rights documentation details, artwork such as movie posters, still shots, or other marketing materials, technical details including filming format and runtime, cast and crew, film trailer and full film file uploads, genre, sub-genre, additional descriptive “tags” and other unique identifying project elements to make the content easier and more accurately discoverable through platform system search features and filters. The completed submission form generates a separate individual page for each project while simultaneously creating a thumbnail image of the project and clickable hyperlink entry in the general buyer library where all content is aggregated, as well as in the uploading users profile page, where they can monitor activity and engagement associated with each piece of content.

Seller's Project Management Tool—Sellers can manage their digital content projects comprehensively. When uploading content to the platform 12, an import wizard allows sellers to load a single project or multiple projects in bulk load mode via the user computing device 30 into the exemplary platform 12 for content that has already been released to the public. This creates individual project pages simply starting from a list of titles coupled to the release year, recorded in the classic format .CSV. All publicly known data can be automatically added to the page, thanks to the integration of the application with thematic partner data companies, drastically reducing the time for entering the project on the platform 12. It is to be understood that “bulk load mode” refers to the ability for the seller to upload content associated with multiple media projects to a storage server of the central computing device 18 simultaneously. The sellers can access the storage server through the use of an access key and/or secret key.

The use of the import wizard improves the speed at which content may be submitted to the platform 12. Additionally, through the use of a community built movie and TV database, the seller can generate an auto-compilation of their project draft. For example, first, the seller will indicate the format, type, and status of their project. Then the seller will type and search for the name of their project in the database. If present in the database, the seller will click on the project poster or icon for the submission to auto-fill with the information presently stored within the database and associated with the particular project poster or icon. If the project is not present within the database, the seller must manually enter all of the required information related to the project.

The central computing device 18 may also implement another wizard that can enable sellers to load the availability of the licenses (e.g., purchase and viewing licenses) to the exemplary platform 12, by importing in bulk load mode. sellers can also use their computing device 30 to add multimedia content, including the film itself, trailers, behind the scenes, interviews, featurettes, and teasers to the project, to make them visible to buyers, via streaming technology, directly on a digital web-based platform. buyers can also add a Script and a Pitch Deck for the multimedia content as well. Sellers can decide, on a single project level, whether to make the script and pitch deck available in the buyers library or just to send screeners to a list of their contacts. The streaming technology is implemented by the user computing device 30 and allows for digital content streams to run in an environment that allows forensic tracking of a user's single viewing session. Watermarking and auditing are applied for the protection of the content, as well as a digital rights management (DRM) application when encoding the media project.

As described here, “script” shall refer to the written text of a play, movie, broadcast, or other form of multimedia content. Additionally, “pitch deck” shall refer to a presentation designed to provide a short summary of the multimedia content to potential buyers.

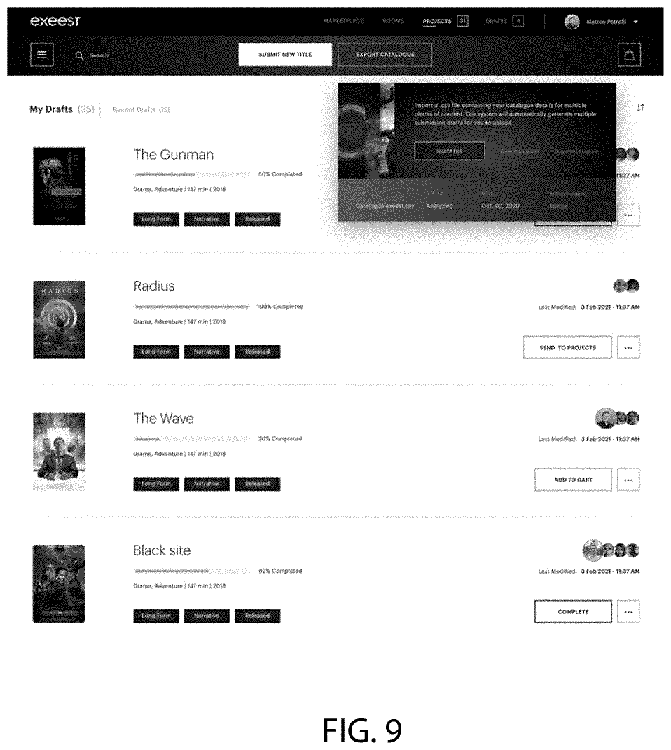

FIG. 9 depicts an exemplary import catalogue page. This feature gives the opportunity to the seller to create multiple drafts simultaneously by uploading a .CSV file.

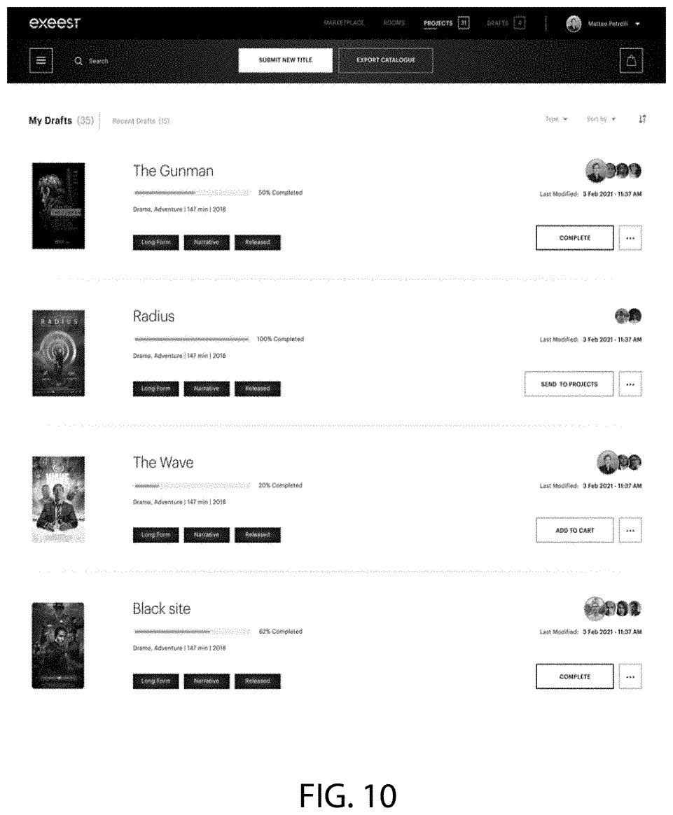

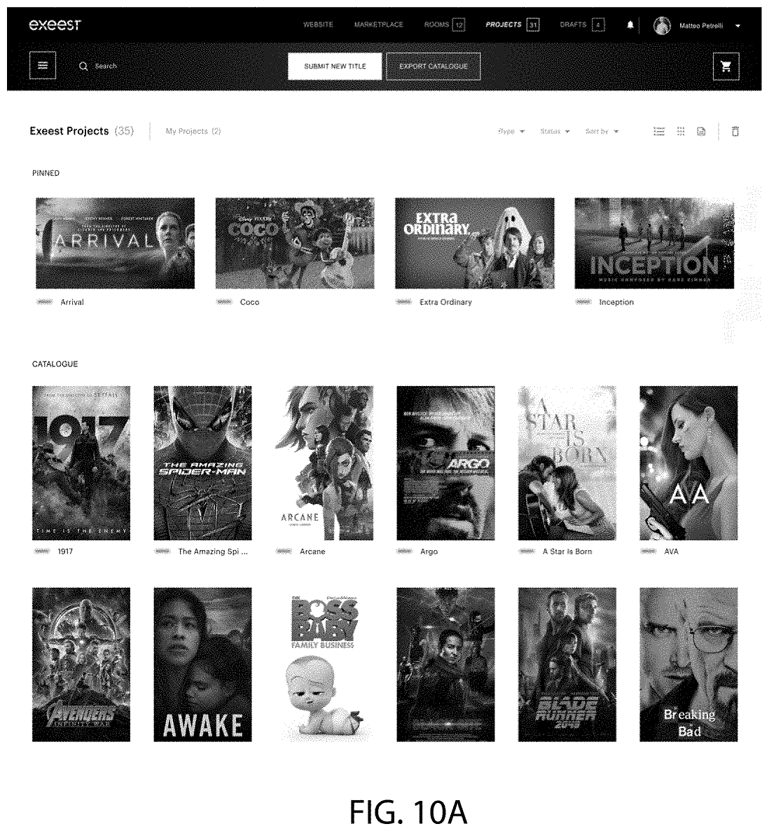

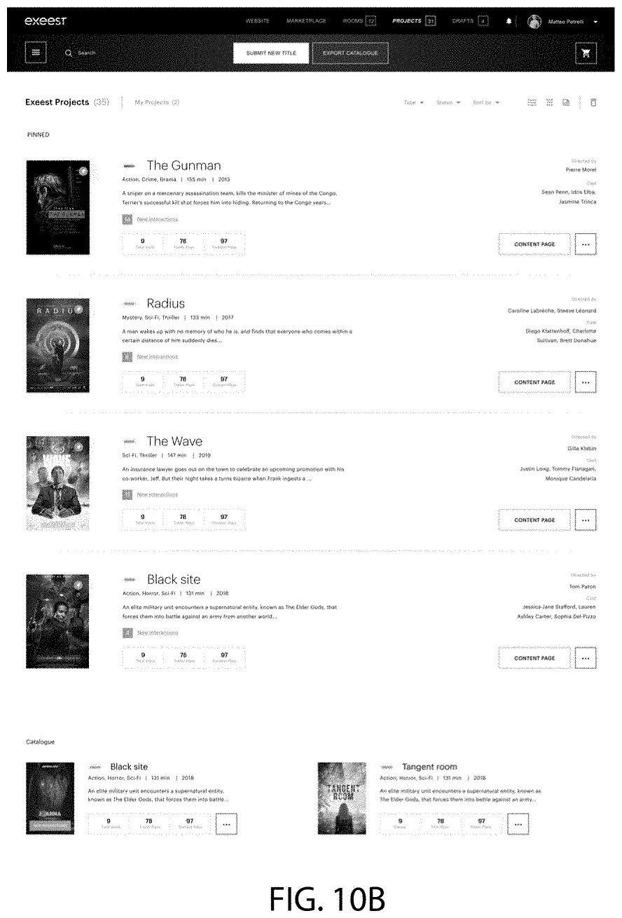

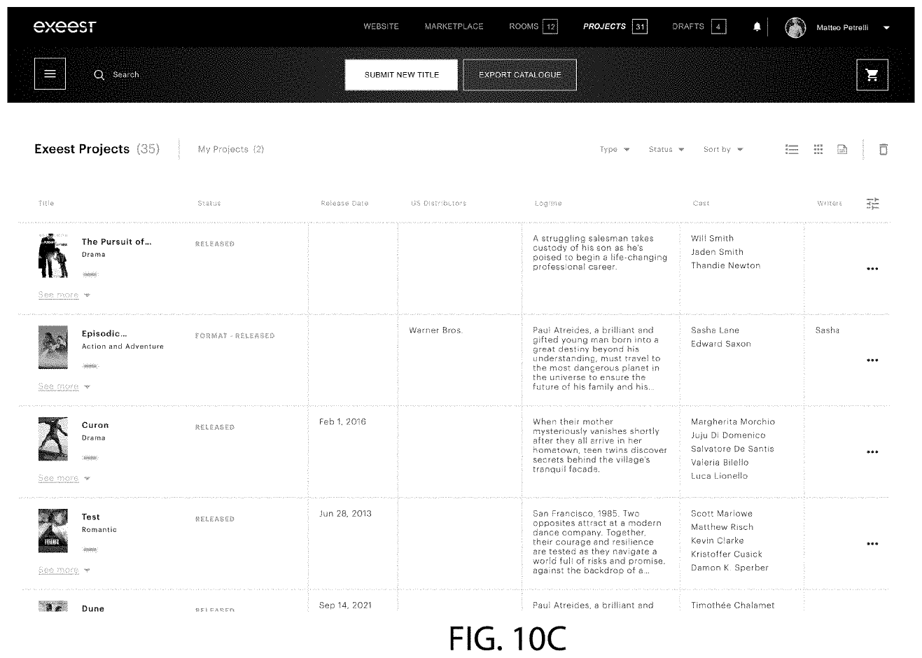

FIG. 10 depicts an exemplary draft page. This is the page where users can access all their ongoing Drafts.

FIGS. 10A-10C depict exemplary pages associated with draft pages. Through this section users can see all the drafts that have been paid and uploaded on the platform 12, as well as their quality range.

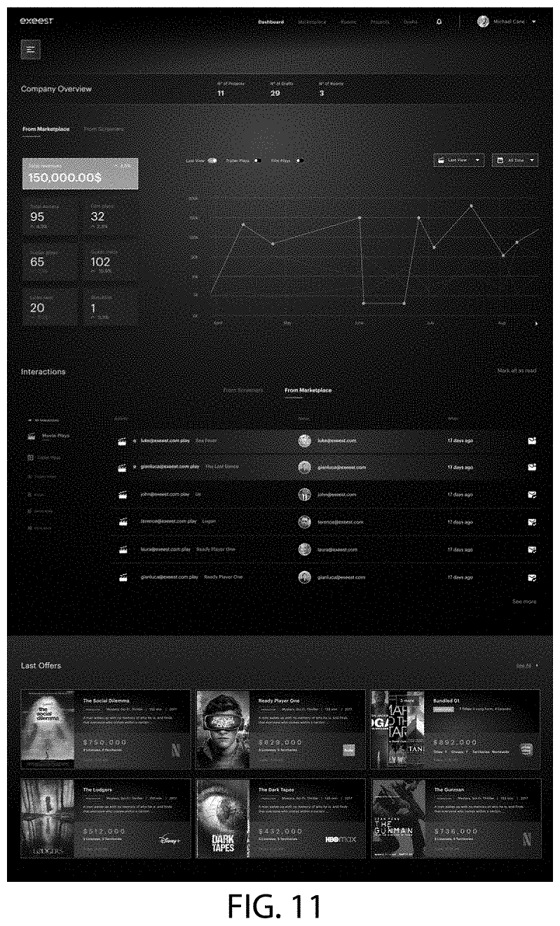

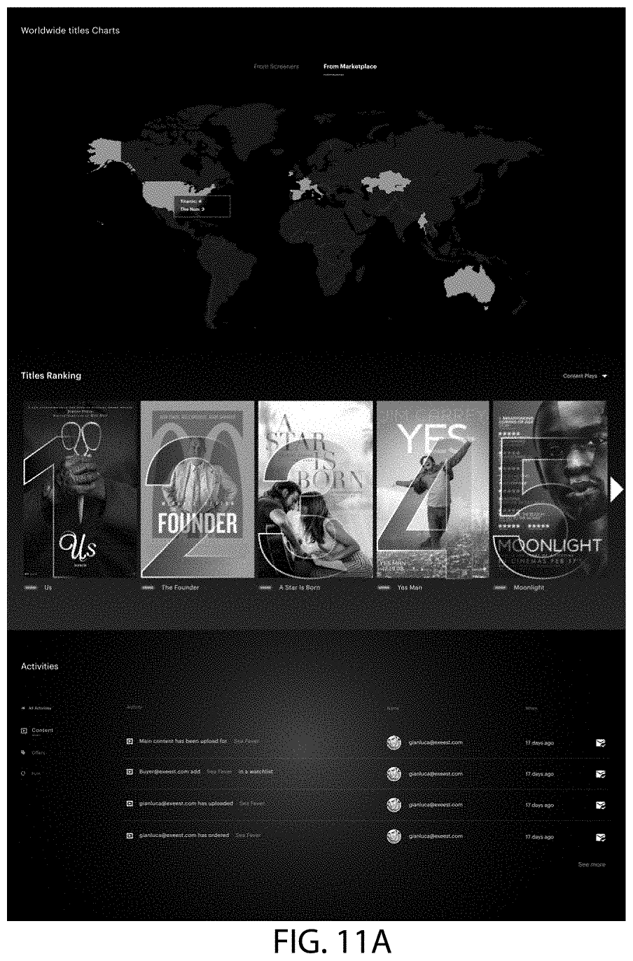

FIGS. 11-11A depict an exemplary dashboard page, which can depict an overview of the analytics of a seller's company. Through this page the seller can easily check the ongoing of the content or trailer views, page visits, percentage of content watched, offers received, etc.

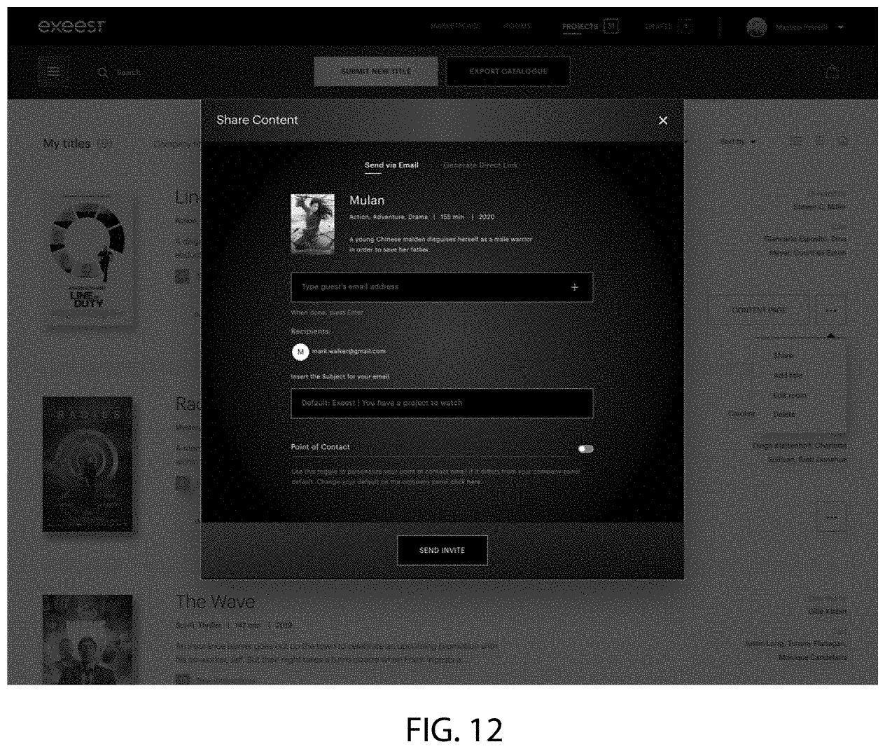

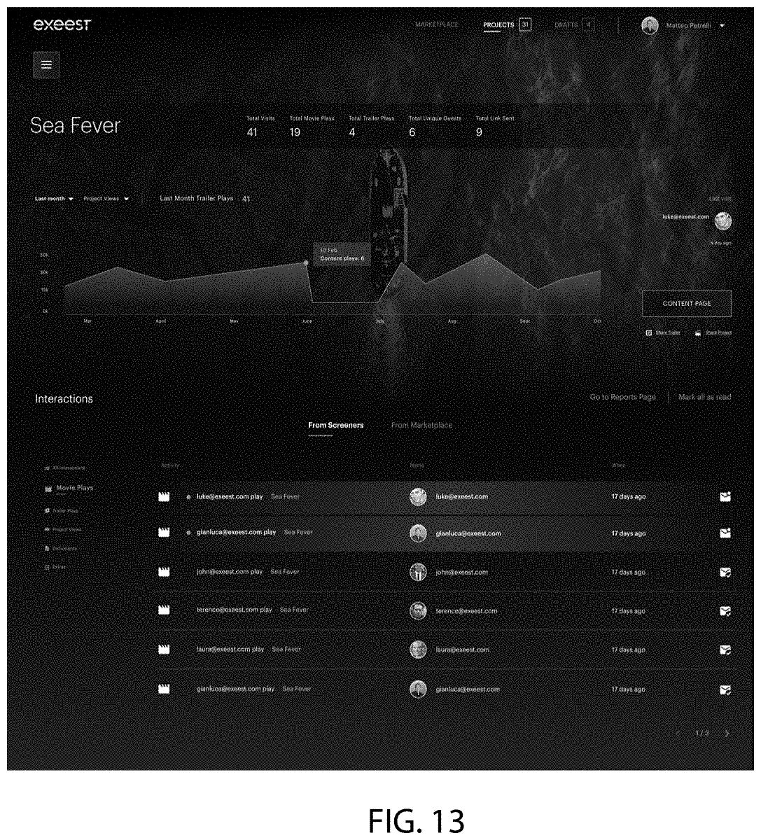

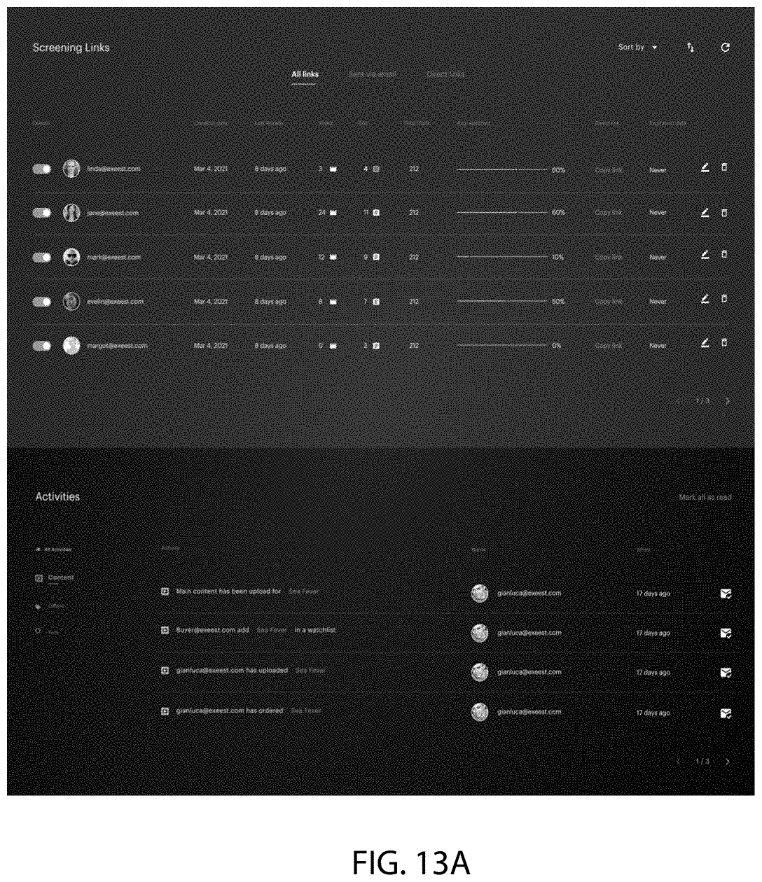

FIGS. 12-13A depict exemplary screener pages. The seller has the possibility to share their projects or other digital content through a link that can be automatically be generated by the platform 12. The seller can add privacy and security settings to this link, such as a password to access it or an expiration date.

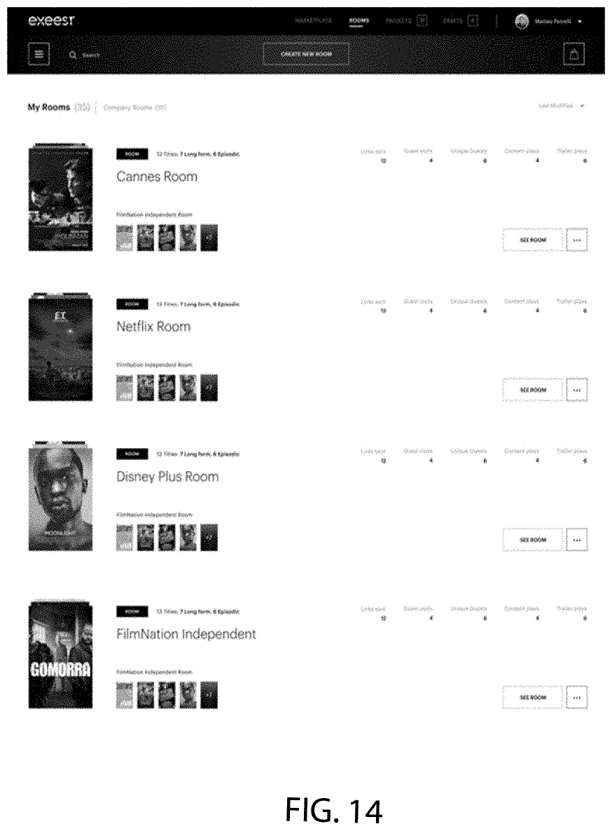

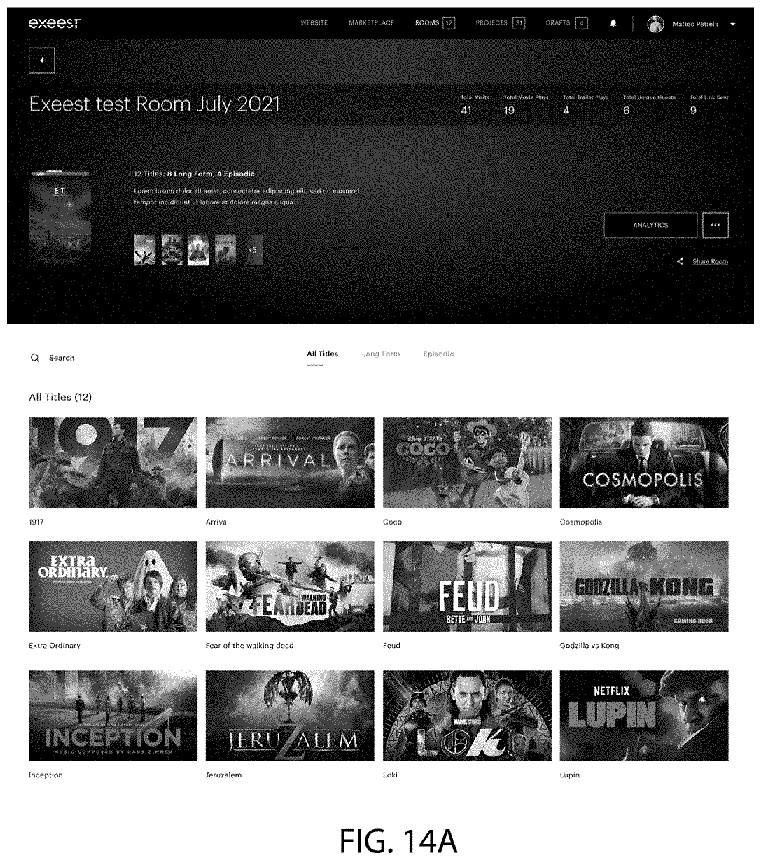

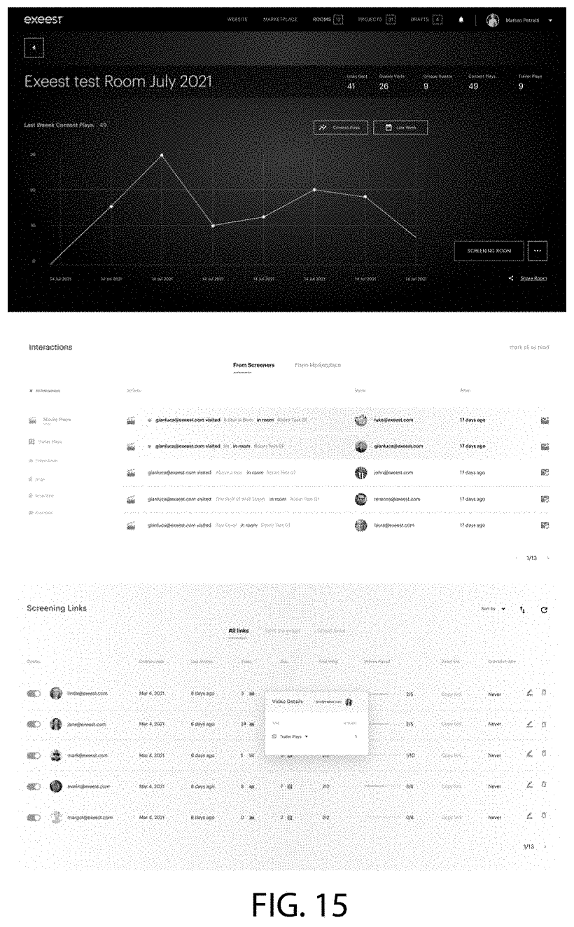

FIGS. 14, 14A, and 15 depicts exemplary screening room pages. Instead of sharing one title, the screening room gives a seller the possibility to share more projects or other digital content through the same link. In one or more embodiments, a screening room needs to be populated at least with two media projects.

Sellers can also import into the exemplary platform 12 their buyer's contact book to which they can send the invitation to view Screeners or Screening Rooms. Screening Rooms are virtual rooms configured to store digital content such as, for example, two or more media projects. Rather than sending an invitation for each stored media project, sellers can create one screening room and send a single invitation for a prospective buyer or other guest user to view all of the media projects stored within the screening room. The invitations can be in the form of an email or a direct link and are sent to buyers through instant messaging applications accessible through the user computing devices 30 of the seller and buyer. The user receiving the invitation can view the invitation (and details/links associated with the invitation) on the interface 42 of their user computing device 30. According to one or more embodiments, the seller can also apply or assign one or more user permissions to each invitation link. For example, when sending each invitation, the seller can choose an expiration date for the invitation, can add a password to access the contents of the invitation, can limit the number of plays of the digital content accessed through the invitation, can choose not to show certain details of the digital content on the page such as rating, availability, technical specs, can inhibit the downloading of the script or pitch deck. Furthermore, to preserve the content from unauthorized copies, sellers can add a watermark to video content, choosing from a QR code that uniquely identifies the user who is watching it and, in some embodiments, also showing the user's phone number in cleartext or a custom watermark.

According to one or more embodiments, sellers can create the screening rooms by clicking on a “rooms” button, tab, or command in a navigation bar of the platform 12 application and selecting, for example, “create a new room.” The seller can see and use this feature only if at least two media projects are uploaded to their account. Once the seller selects “create new room”, the seller will be prompted to create a title for the room, a description for the room, and pick at least two projects to store within the room. Screening rooms allow sellers to upload digital content to the digital web-based platform 12 and store the digital content within the screening room. Sellers can then deliver invitation links to prospective buyers (or other types of users) so that the buyers can be directed to the screening room and view the digital content. According to one or more embodiments, the seller may at any time inhibit or restrict the viewing of the content to one or more users by disabling the invitation links individually as needed. The user computing device 30 is configured to allow the seller to disable the invitation links as desired by sending a termination signal or message to the central computing device 18 which then removes the access granted to the stored digital content that was once afforded by the invitation link. This allows sellers to always have full control of who is watching their content. Also, the seller may also have a panel dedicated to statistics, which informs sellers in real-time who is watching what and how they interact with it. In both granular and aggregated form, sellers can see if guest users open the invitation, view the page, view the supporting content, the duration that the visitor viewed the media content, and even if the visitor viewed it multiple times. This information can be stored in a log or series of logs that record the guest user's activity and can be indicative of a user event. The logs may be stored in the server database and in system software that enables the central computing device 18 to analyze the events. Whenever a new event to be tracked is added (e.g., tracking of which episode of a show has been seen), the vendor will add a log that will save the data on the database from that point onwards.

It should be understood that the panel is part of the platform 12 and is accessible via a internet web browser by each of the user computing devices 30. The panel can provide an overview of the analytics associated with each screening room and the analytics associated with each project stored within the screening room.

Visitors who receive invitations to view Screeners and/or Screening Rooms, if requested by the seller, must go through two-factor authentication (email and phone call or text message). In this way, when the visitors log in to the exemplary platform 12 via their own user computing device 30, they can use a personalized page containing all the invitations received, even from different sellers. This is to enable visitors to better manage all requests and take note of the content deemed most interesting. Visitors, like buyers, can in fact, for each title, add personal notes and/or a rating, can forward the project to other people in their organization, and interact with them. It should be understood that the personal notes and/or ratings may be entered via the guest user's user computing device 30. In some embodiments, guest users may enter the personal notes and/or rating through the use of the interface 42 that is integrated with the user computing device 30.

According to one or more embodiments, to send invitations to watch a single project, the seller can navigate the platform application and share the invitations by emailing links to designated email addresses, or by generating a unique direct link that can be copied by the seller and provided to customers or buyers via email or other messaging systems.

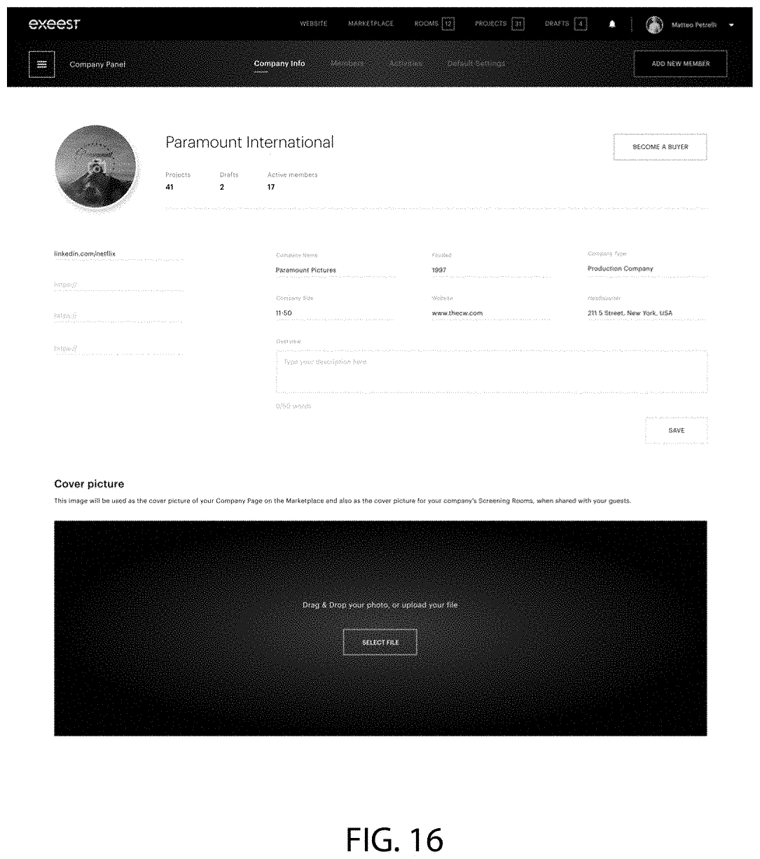

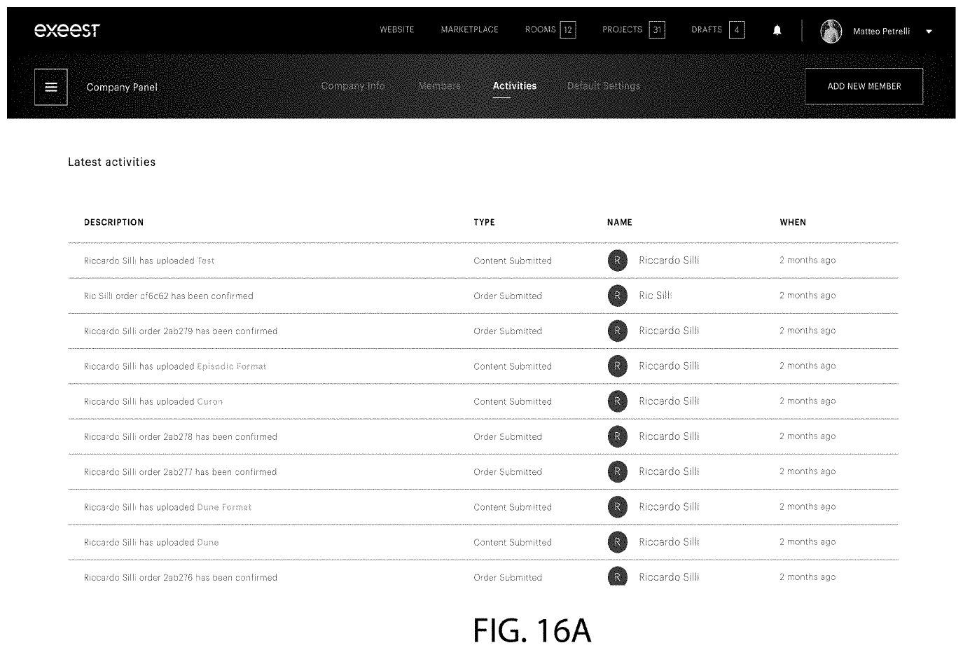

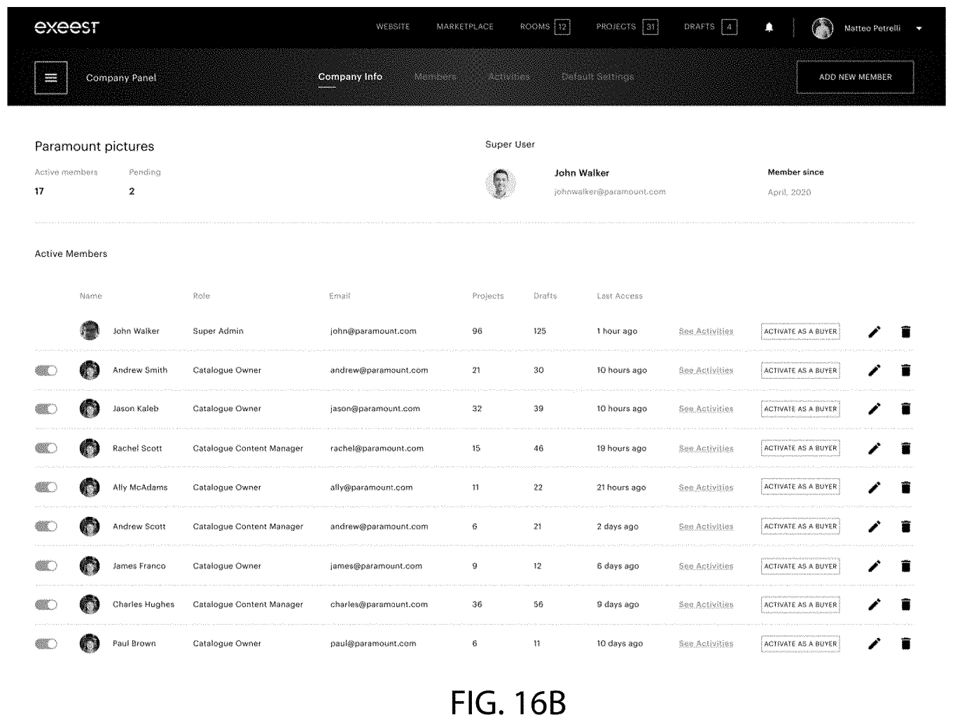

FIGS. 16, 16A, and 16B depict an exemplary company panel. Every company panel administrator can manage its members (such as the sellers) and activities through the Company Panel. The company panel administrators can add new members and choose their role depending on the authorizations or user permissions the administrator wants them to have. The company panel administrator can also modify or delete the profiles of other sellers.

Additionally, the company panel in the exemplary platform 12 allows different employees of a seller to interact on the same content. Each company designates its administrator(s), who can add or remove members, assign a specific role, and control the activities performed within the vendor's platform 12. Users of the same company can thus communicate and collaborate in the creation of projects and their management, without the need to use other external messaging applications.

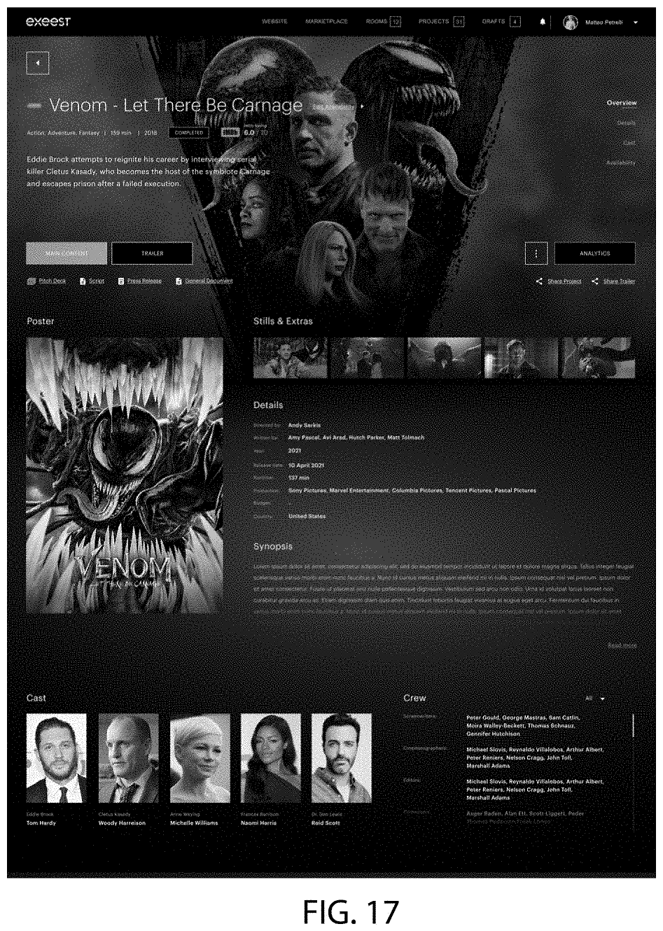

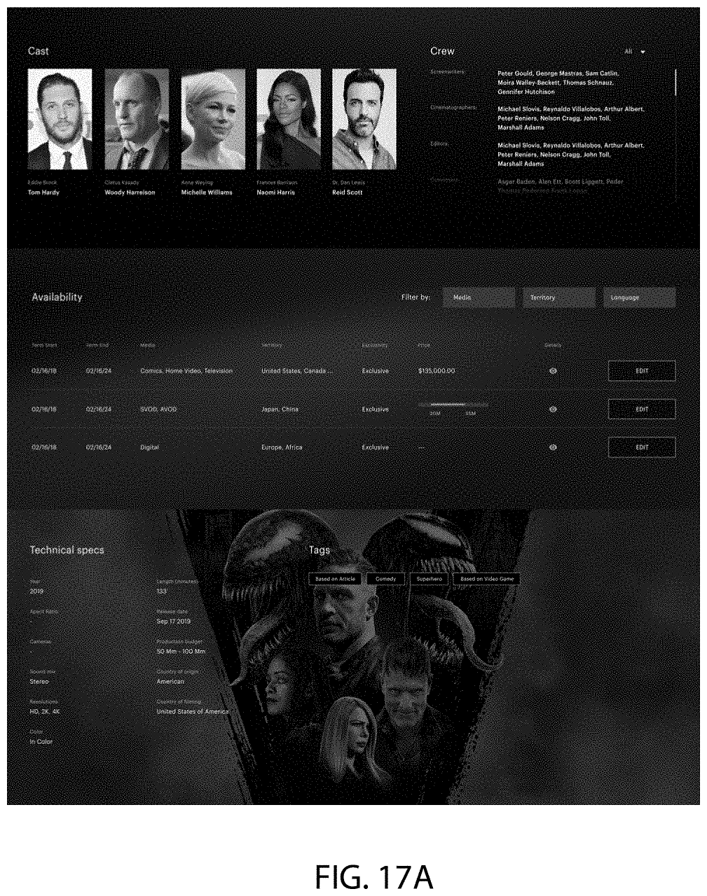

FIGS. 17-17A depict an exemplary content page, which is the result of the submission form. sellers will be able to see all the data and media they entered about their title. Moreover, they can have a preview of what prospective Buyers will see about their digital content. This page is accessible by clicking on a title's poster or icon in the projects page or on the “content page” button next to the project's title.

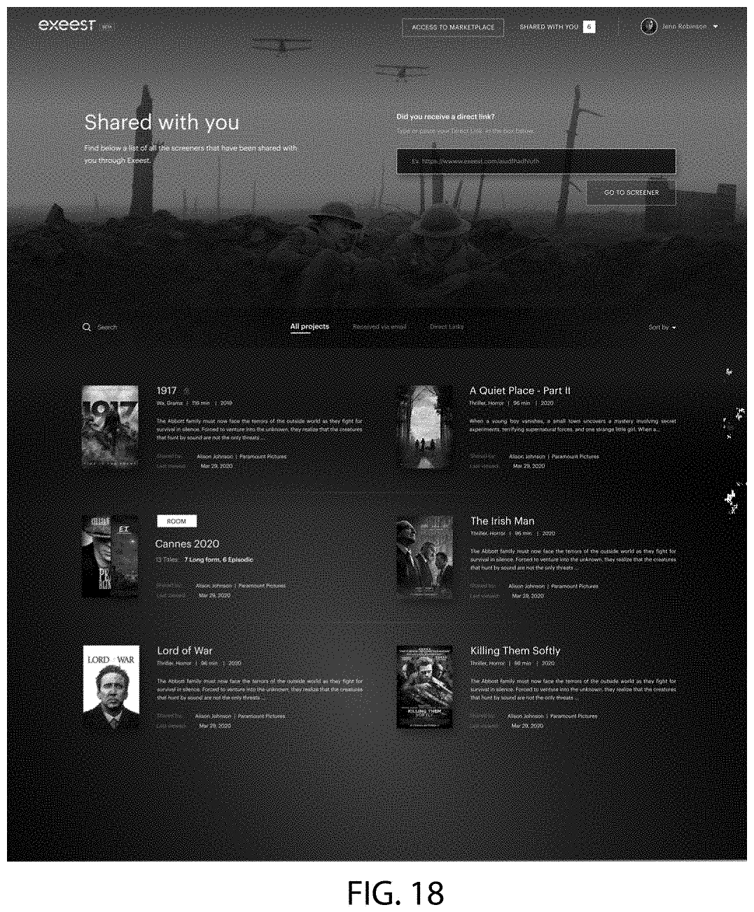

FIG. 18 depicts an exemplary guest panel on the platform 12, where the guest user can view all the screeners they received by a seller or multiple sellers. As used herein, a guest user may be a user who has been invited by the seller to view the seller's digital content. As a non-limiting example, a guest user could be a prospective buyer, a journalist, or a film critic, etc. The guest panel allows the guest user who is invited to view a project on platform 12 to have their own dedicated environment in which they can manage all the invitations received, even from multiple sellers. Guest users can therefore easily manage new invitations and those received previously, having the possibility to add those of his interest to the favorites list, as well as all the possibilities of viewing, contact and purchase proposals, which are available for each buyer. Guest users can view all of the information on the digital content associated with the invitation on the panel.

Address book—To facilitate the sponsorship process of the uploaded digital content, sellers can take advantage of a special contacts directory in the exemplary platform 12, from which they can easily select the contacts to which they can send screeners, screening rooms, marketing material, newsletters, all with detailed traceability of interactions and with invitations made in advance. In one or more embodiments, contacts can be aggregated into groups of relevance, geographical area, roles, skills and more.

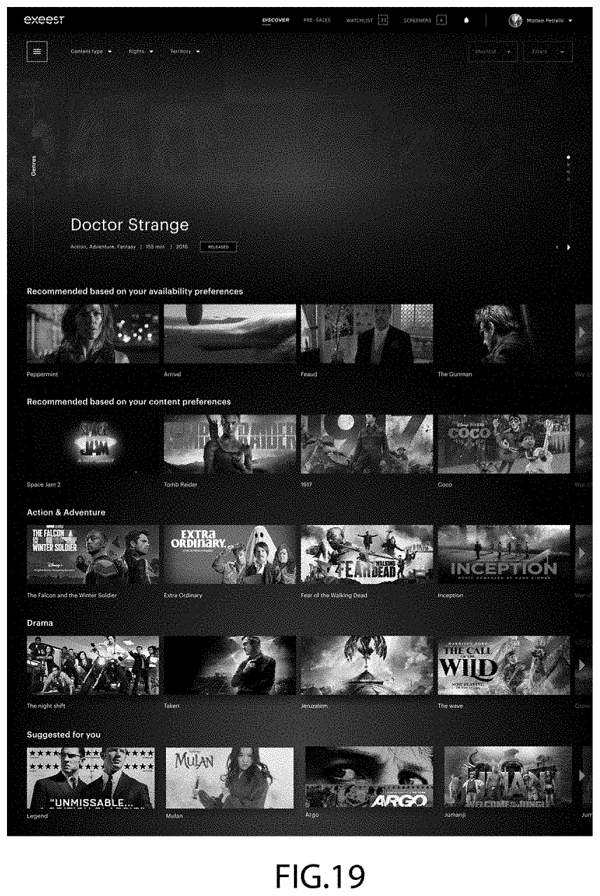

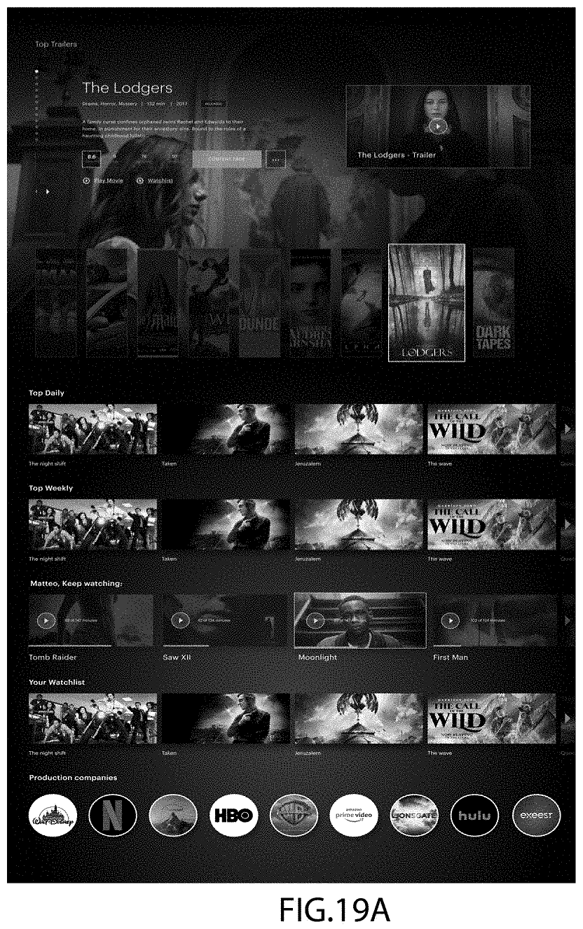

FIGS. 19-19A depict an exemplary home page of the buyer platform where a buyer can browse around all the content uploaded by the sellers.

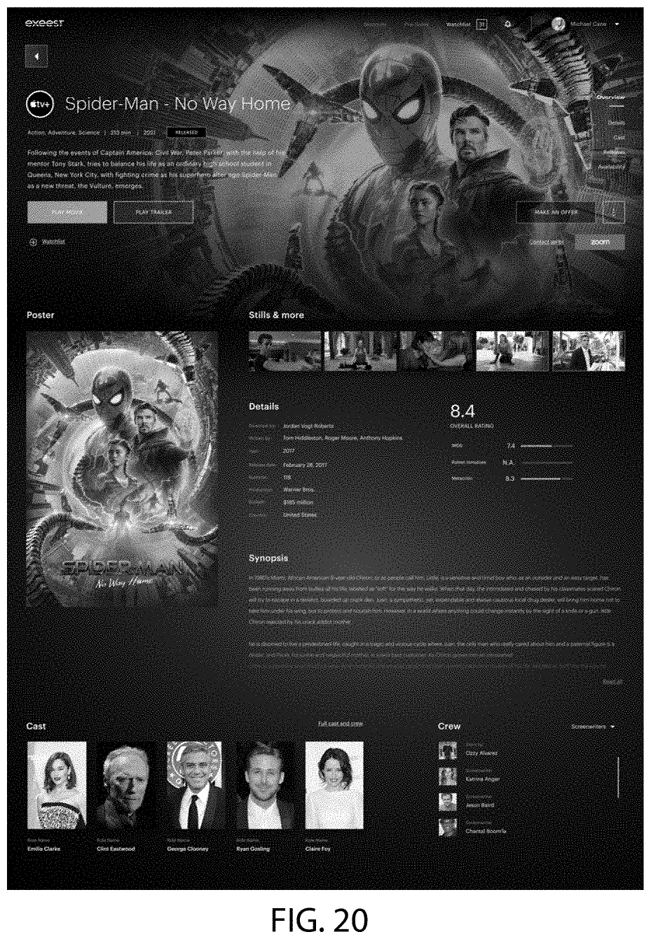

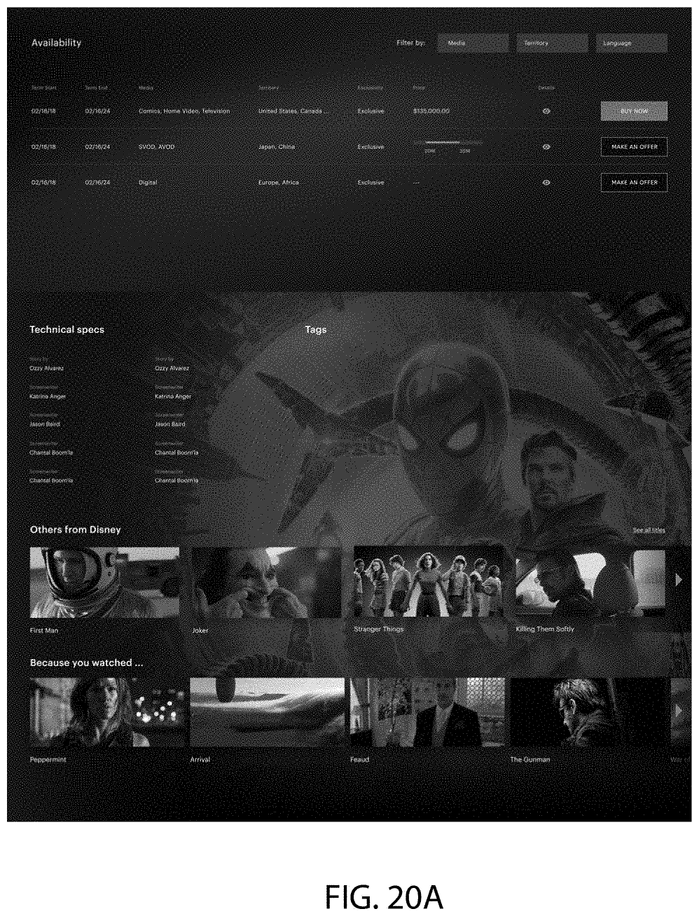

FIGS. 20-20A depict an exemplary page where the buyer can view all the data, information and media about the project, including the main content (full length video).

The central computing device 18 can then distinguish the content and types of licenses, then suggest titles similar to those displayed and saved in the watchlist, for which the buyer made an offer. The content shown to buyers is therefore based on the buyer's preferences provided at the beginning or obtained from the machine learning system depending on the type of content, genres, availability, tags and more.

Saving Content to Review Later—The platform 12 is also programmed and/or configured to enable users to at least temporarily store content for viewing at a later period of time. For example, when a buyer comes across a piece of content they think might be interesting to review in greater detail at a later time, they could “save” that content to a “list” that is stored in their profile. Multiple lists can be created for different topics, events, or situations. For example, a Christmas Movie list could be created and any interesting films that might be worth purchasing or licensing during Christmas time could be saved and reviewed later. It should be understood that although the content may be stored for viewing later, the content cannot be downloaded by guest users, buyers, or any other user. In other words, the digital content is only accessible for digital streaming.

Sharing Content with Other members at Buyer Organization—Buyers could use a “share” button to notify another member at their company, who also has a valid account in the platform 12, about a piece of content that could be worth acquiring or licensing. For example, this could be used to notify a colleague about an interesting piece of content, or it could be to notify someone that specializes in a certain type of content about something interesting that a person has come across.

### Streaming Platform

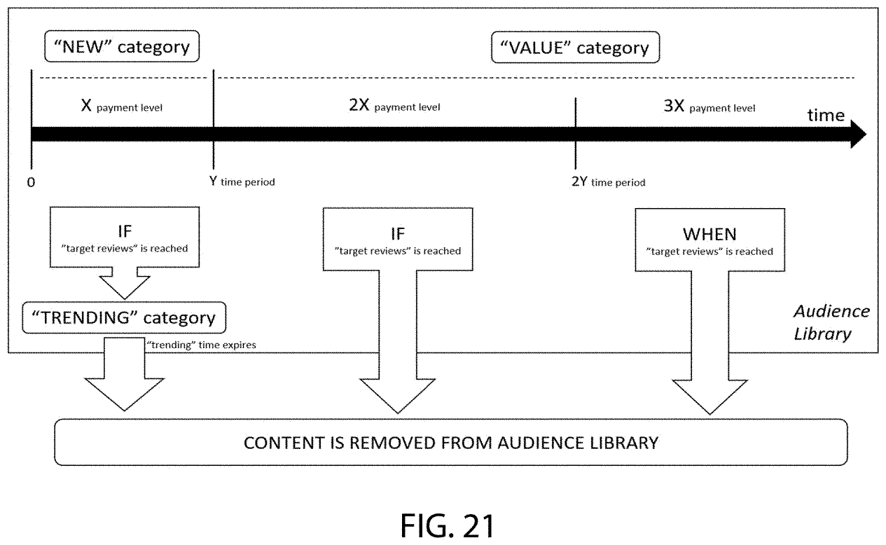

Now referring to FIGS. 1 and 21, the exemplary system 10 may also include a streaming platform 44 that may communicate with and be used together with the platform 12 via API connection 16c. The streaming platform 44 may also be implemented by the central computing device 18 and may be integrated within the platform 12. The streaming platform 44 offers an integration of the services offered by platform 12 and allows sellers to be provided reviews of their digital content from designated audience member users. For example, while sellers and buyers interact through the use of platform 12, audience member users perform all their processes (such as watching and reviewing the seller's digital content) exclusively on the streaming platform 44. Audience members can access the streaming platform 44 through a web-based connection 14b which is accessed by the audience member's user computing device 30f.

The streaming platform 44 is connected via “server to server” APIs connections (such as API connection 16c) to platform 12 and from this it extracts data to allow audience member users to view the library designed for them and all the functions described below, including streaming. All accounting data is saved exclusively in the streaming platform 44, while the review data are also replicated in the platform 12 cache memories. The streaming platform 44 is an exemplary streaming platform created to pay viewers instead of them paying a monthly subscription fee; “the first streaming platform that pays you to watch content”.

The exemplary streaming platform 44 is also designed to create an opportunity for content creators who want to be discovered; to receive an objective opinion from audiences on their content. The streamers are explicitly paid to anonymously provide a detailed and impartial review.

The service's main characteristic is a self-regulation algorithm (as shown in FIG. 21), which guarantees that the content is reviewed a minimum number of times, as set forth and paid for by the seller.

After the peer reviewed screening process, the content is displayed in a library (discussed in more detail below), where buyers can discover content using the audience ratings as well as classic searches like genre, director, actor, nationality, language, etc. Thanks to the screening process carried out by reviewers, buyers can have the opportunity to focus only on the most noteworthy projects.

The sellers, such as content creators or rights holders, register on the exemplary platform 12 and upload their titles or media projects for streaming. Each seller can submit each of their works to a target audience or audience member, declaring how many people it should be composed of and what characteristics it should have, choosing from: age, gender, ethnicity, language, nationality, geographical location. For example, during the submission form for an uploaded project, in the “Review” section (or other similar section) or subsequently to it, sellers can submit their content to an audience Member by clicking on the “Buy audience Member Review” button. Sellers will have to pay an additional fee and choose the characteristics of the audience member.

### Projects

It is to be understood that media projects can exist in the exemplary streaming platform 44 in the following formats: long form, short form or episodic, and in varied types: narrative, documentary, animation, special (comedy). Each project can be described with specific details including title, logline, synopsis, director, crew, cast, executive producers, producers, distributors, production companies, technical specs, language, genre, and miscellaneous tags. Furthermore, in addition to the full length video, creators can add: cover, poster, stills, script, pitch deck and extras: trailer, featurettes, behind the scenes, interviews, teasers etc.

### Digital Audience

Any person can register to apply as an audience member with exemplary streaming platform 44. Each person is verified through a KYC (Know Your Customer) procedure and admitted as a member of the audience. Each audience member must specify their own: date of birth, gender, ethnicity, languages spoken, preferred film genres, interests, work and hobbies, so that they can be easily placed in clusters of people who meet the requirements of the content creators. The KYC procedure may be a two-step verification process that includes ID verification and biometric authentication from the audience member, and is only available via the streaming platform 44.

### Screening Process

After uploading the project to the exemplary streaming platform 44, the content creator requests a screening, choosing the minimum number of people to provide reviews, in increments of 12, 25, 50, 100 or more. Furthermore, sellers can request to target their audience, so that a desired or selected media project is presented only to specific demographics or predetermined groups of audience members. This can be very useful because if the content of the selected media project is a horror movie directed at teenagers, it is counterproductive to be reviewed by women ages 60+ who love romantic comedies.

The phases of the screening process are described in the dedicated section “CALCULATION OF DYNAMIC PAYMENT LEVELS FOR AUDIENCE MEMBERS”. VERIFYING DIGITAL AUDIENCE MEMBER FEEDBACK

Upon completing the screening of a film with the exemplary platform 12, audience members can be presented with a few brief questions in order to verify that they did in fact watch the film. Upon completing these questions correctly, they can then be able to move on to provide their evaluation and feedback. In other words, sellers can use their respective computing device 30 to program the platform 12 and/or streaming platform 44 to present verification questions to audience members to verify that the audience members did in fact watch, and pay attention to, the shown media project. The platform 12 and/or platform 44 are programmed and/or configured to transmit the questions to the audience members' computing devices 30 so that the audience member may view and answer the questions using their respective device.

### Content Rating and Evaluation by Digital Audience Members

Reviewers, such as audience members described herein, provide feedback on media projects using their computing device 30. The provided feedback may include an overall numerical score and scoring for individual elements of the project such as story, acting, cinematography, music, etc. Audience members can also choose to provide qualitative commentary as well, which can become interactive with other audience members that have reviewed the same media project. This data is attached to the project and becomes visible for prospective buyers in the library.

### Digital Audience Library

According to one or more embodiments, the streaming platform 44 may also include a library of media content. The library of media content may be created dynamically for each audience member such that the titles are displayed, as determined by the system 10, based on the audience member's choices, previous behaviors, and prior media interactions. The audience member has the possibilities to: create a list of favorites, assign a rating, enter personal notes, indicate the films they are not interested in, remove titles from the “Keep Watching” section, in addition to having to respond to questionnaires that assure the company that it has actually viewed a content in full.

### Audience Member's Library

According to one or more embodiments, a library of media content in the exemplary streaming platform 44, is created dynamically for each audience member based on the audience member's previous choices, behaviors, and interactions (i.e., viewing preferences). In some such embodiments, the system 10 determines, based on an estimated level of audience member interest based on the previous viewing preferences, which media projects should be presented. The audience member has the possibilities to: create a list of favorites, assign a personal rating, enter personal notes, indicate the films they are not interested in, remove titles from the “Keep Watching” section. A comprehensive filter engine can help the user to find the most interesting titles for their objectives. Although not described in detail herein, it should be understood that in order to monitor and record an audience member's viewing preferences in order to generate a personalized or dynamic library of media content, the system 10 may utilize the hardware and software of the audience member's computing device to perform the required operations and functions to carry out this process.

### Calculation of Dynamic Payment Levels for Audience Members

Now referring to FIG. 21, a payment system 46 implemented by the streaming platform 44 via the central computing device 18 is shown. To increase the likelihood of matching with prospective buyers, sellers can utilize the streaming platform 44 to receive feedback on their digital content from audience members users. Using their user computing device 30, Sellers can select a digital audience size: 12, 25, 50, 100, or more people (such as audience members) and demographic groups like “18-25 year old Hispanic males”, who are then given the opportunity or provided access to watch, review, and provide feedback on a seller's work, in exchange for a monetary payment. Feedback that can be provided by the audience members includes both quantitative feedback, such as a one to ten rating across metrics like story, acting, cinematography, etc., as well as qualitative commentary about anything related to the media project, that an audience member would like to share.

According to one or more embodiments, when implementing the streaming platform 44, the central computing device 18 is configured and/or programmed to determine and generate a level of payment that should be given to an audience member reviewing media projects on the streaming platform 44. To determine the level of payment given to the audience member who views the content, the computing device 18 implements an algorithm that calculates this amount dynamically based on user engagement received on the digital content itself. This dynamic paradigm is necessary to maximize the odds that all digital content seeking an audience Evaluation is reviewed, even those deemed less interesting.

The underlying concept of this algorithm is that, if the content is interesting/receiving high levels of engagement on the streaming platform 44, the audience member is paid less to view and score it. If instead it is considered by various audience members as not very interesting, the reward to watch and review the content is higher.

Unlike VOD platforms, in which an user pays or watches advertisements to view digital content, the system 10 enables audience members accessing the streaming platform 44 to be paid for viewing a particular media project content, provide a quantitative score, and writing a short review. In this case, audience members approach viewing content with a different attitude. A user on a typical VOD platform will look to watch content that best suits their interests. With the exemplary streaming platform 44, audience members can be motivated to watch content based on a higher payment level, which, among other things, could be synonymous with a poor product as it requires a higher level of compensation in order to get someone to watch it. The end result should be a lower score for content that demonstrates low engagement and thus requires a higher monetary reward to entice an audience member to complete the review process.

When a creator or seller uploads content to the library for an audience evaluation, the exemplary streaming platform begins monitoring the levels of engagement with each piece of content to determine a payment level necessary in order to get audience members to watch and score the piece.

All content, based on their type, originate with the same audience payment level.

As shown in FIG. 21, content is then divided into 3 categories, that represent their status: “NEW”, “VALUE”, and “TRENDING”.

The “NEW” category includes content that has been recently uploaded/added to the library for audience review.

The “VALUE” category includes content that currently offers a higher payment level because they have been experiencing low levels of engagement on the platform and the system has determined that a higher monetary reward is required in order to get an audience member to watch and review the content.

The “TRENDING” category includes content that offers zero payment because it has already received very strong engagement from other audience members and the system has been determined that members are willing to watch and review the content for free. Content in this category is likely of higher quality.

Now referring to FIG. 21, according to one or more embodiments, the central computing device 18 implements the following algorithm on the streaming platform 44 to determine and/or calculate the audience member payment levels:
A content creator/Seller uploads their media project to the library.
The central computing device 18 automatically files the media project in the “NEW” category, at variable “X” payment level (equal for all, example: $5 for a feature film) for a variable “Y” time period.
The central computing device 18 monitors and/or detects the amount of views or reviews the digital content received from audience members.
As soon as the content reaches its predetermined “reviews” target (the number of audience Members views that the seller chose and paid for), it is placed in the “TRENDING” category (at $0 remuneration) for a specific time period (for example, 72 hours), so that it can accumulate additional “organic” views and reviews from audience members.
If at the end of time variable “Y”, the content has not reached its “reviews” target (meaning that the Seller requested, for example, 25 audience members to review their project, but only 15 completed the process), it is placed in the “VALUE” category for variable “2Y” time period, offering a variable “2X” remuneration.
If, during the variable “2Y” time period, the “reviews” target is reached, the content is then removed from the audience library.
If, at the end of the variable “2Y” time period, the content has not yet reached its “reviews” target, it is proposed at variable “3X” remuneration until the target is reached, then the content is removed from the audience library.

Note that there could be more than fifteen categories and the “VALUE” category itself can be split into more than 2 payments levels. For example, “VALUE” could be split into 4 levels such as: 1.5X, 2X, 2.5X, 3X.

In addition, reaching a target of 12 audience reviews is obviously easier than reaching a target of 100. For this reason the time variable “Y” could also be dynamic and in proportion to the predetermined target. For example: A piece of content that requests an audience of 12 members could be given 24 hours to complete the review process; an audience of 25 members could be given 48 hours to complete the review process; an audience of 50 members could be given 96 hours to complete the review process; an audience of 100 members could be given 192 hours to complete the review process.

During the time that the content is available in the audience library, the exemplary platform 12 can collect data related to all user actions, which can also help determine useful statistics for buyers to determine the hypothetical level of engagement of the content on the real market. For example, when users use their user computing device 30 to access the platform 12, the user computing device 30 and/or central computing device 18 can record and store user information and data. The stored information may be kept within, and retrievable from, the memory 26, 38 of either the central computing device 18 or the user computing device 30. Is some embodiments, the central computing device 18 is further configured to receive the transmission of information and data from the user computing device 30.

There are some “micro” user action scenarios that the exemplary streaming platform 44 (using either the central computing device 18 or user computing device 30) can monitor to collect user data. These are based on various ways users interact with content on the platform or in the library like, watching the trailer, watching the film, adding content to watchlists, how long they watch the trailer, how long they watch the film, do they convert from watching the trailer to watching the full film, how long do they watch the trailer before converting to watching the film, how long do they watch the trailer before adding it to a watchlist, when do they go back to view a film they've added to a watch list, etc. Time and length of engagement, depth of engagement, and follow-up interactions, along with other variables, all can have an impact. More specifically, for example, some of the scenarios include:
a) User ignores a particular content poster (e.g. poster for a movie), flyer, or icon and/or summary data displayed in the library, and clicks on another piece of content;
b) User clicks on content poster to view more information (logline, director, actors, language, presence of subtitles and more);
c) User starts viewing the trailer associated with the content;
d) User starts viewing the trailer and stops, without adding the content to a watchlist;
e) User starts viewing the trailer, stops, and adds it to a watchlist which they then never watch again or watch it eventually;
f) User starts viewing the trailer, watches the whole thing, then does not watch the content or add it to a watchlist;
g) User starts viewing the trailer, watches the whole thing, then watches the content;
h) User starts watching the full content, but stops (after a percentage of time) and abandons the viewing (and does not click “SAVE FOR LATER”);
i) User completes the viewing of the content
j) User passes the “review test”, the questionnaire to assess whether the user has actually seen the content with the right attention; and
k) User submits a completed review for a piece of content

Moreover, these variables are also taken into consideration:
l) IF and WHEN the content enters the “TRENDING” category;
m) How many “impressions” the content needed to have one complete review;
n) The number of views and reviews obtained for a piece of content when it is in the “TRENDING” category; and
o) The number of organic reviewers that rated content in the “TRENDING” category.

When the data collected will start to be statistically relevant, the exemplary platform 12 can begin to provide additional information to buyers, to indicate engagement values on the product that are below or above average, in order to help them in the process of selecting interesting content to buy.

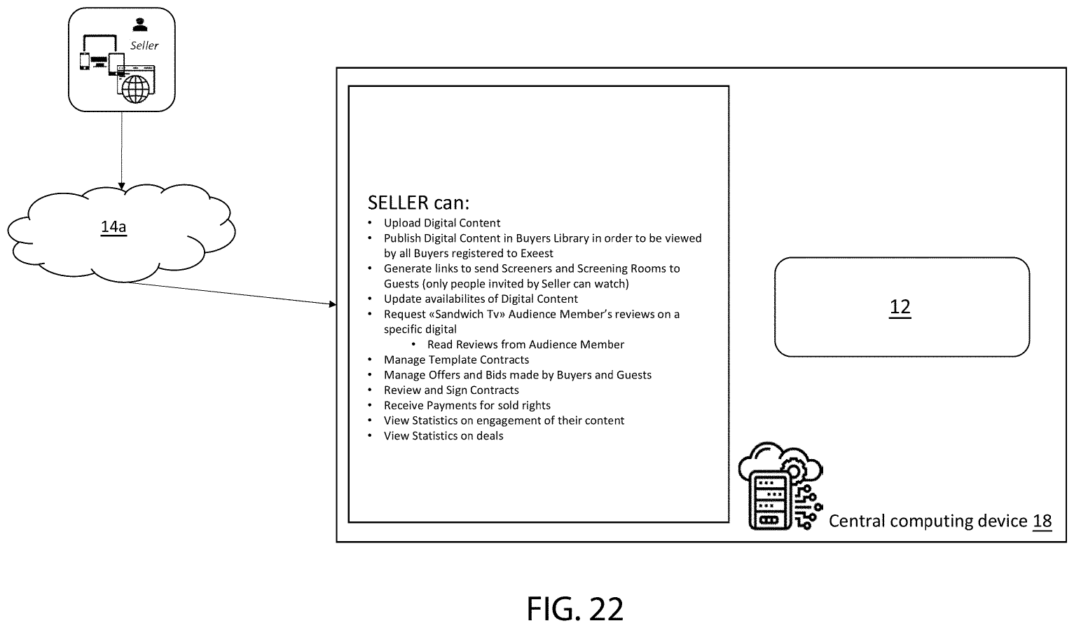

FIG. 22 depicts a block diagram of the following seller processes associated with the exemplary platform 12 in accordance with the principles of the present invention:
Upload digital content from the user computing device 30 to the platform 12;
Publish digital content in a content library accessible to buyers in order to be viewed by buyers registered to access the platform 12;
Generate links to send screeners and screening rooms to guest users (only people invited by the seller can watch the digital content);
Update availabilities of digital content;
Request, from the streaming platform 44, audience member reviews on a project;
View the reviews from each audience member;
Manage template contracts;
Manage offers and bids made by buyers and guest users
Review and sign contracts electronically;
Receive payments for sold rights to a project;
View statistics on user engagement as it relates to a particular project; and
View statistics on deals.

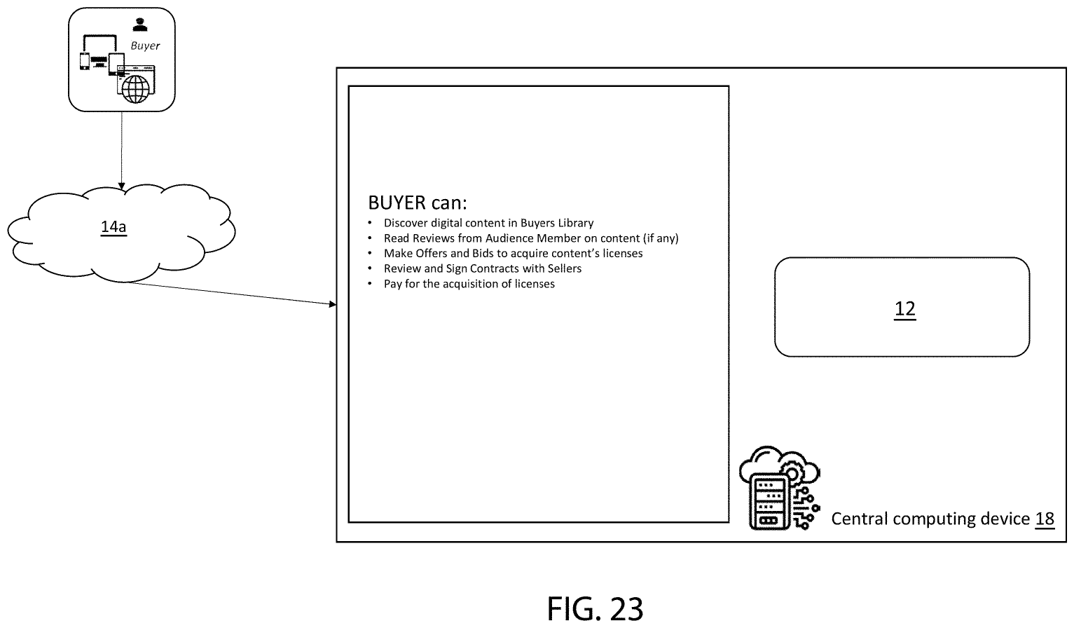

FIG. 23 depicts a block diagram of the following buyer processes associated with the exemplary platform 12 in accordance with the principles of the present invention:
Discover digital content in a digital library associated with the buyer. For example, the seller may grant the buyer access to a library of digital content uploaded by the seller or the buyer may have their own dedicated library that they can store projects in for viewing at a later date;
Read reviews from audience members on the seller's digital content;
Make offers and bids to acquire content licenses from the seller;
Review and sign contracts with sellers; and
Issue payment for the acquisition of licenses.

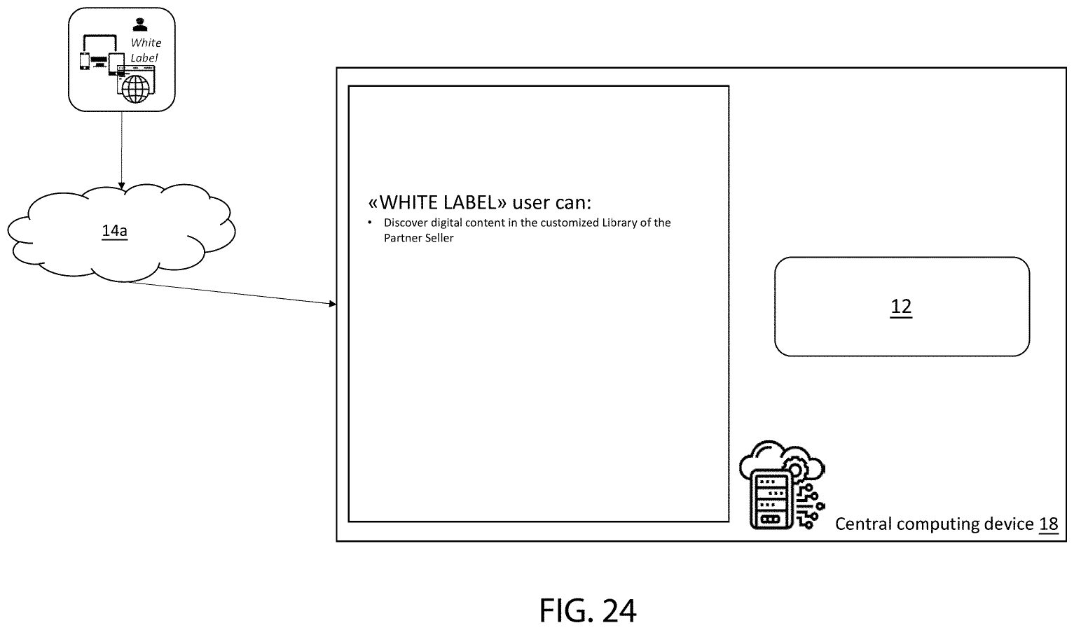

FIG. 24 depicts a block diagram of the following white label processes associated with the exemplary platform 12 in accordance with the principles of the present invention:
Discovered digital content in the customized library of a partner seller.

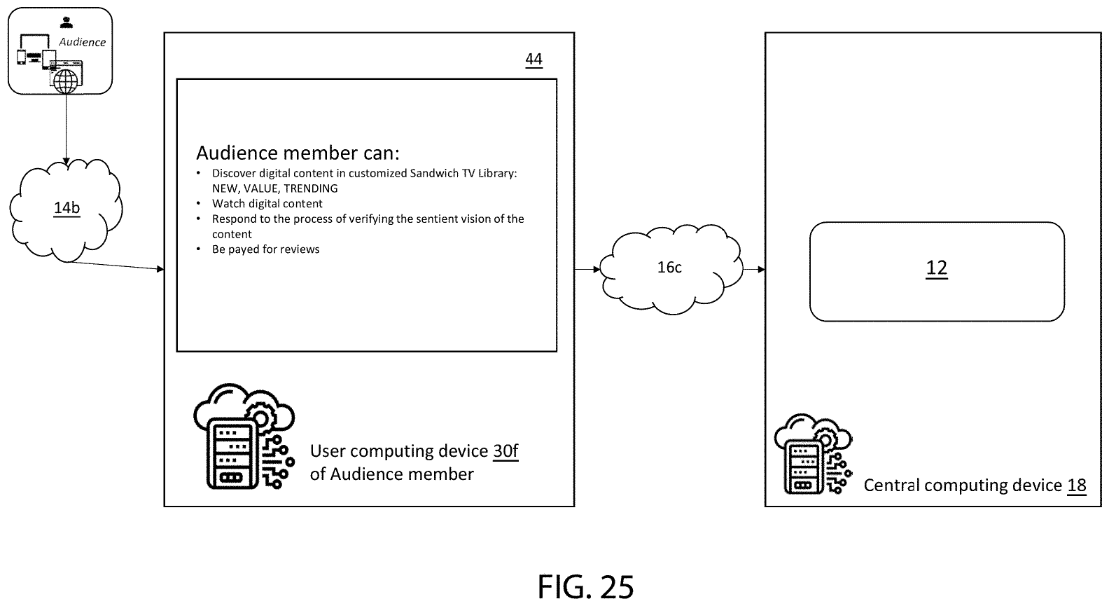

FIG. 25 depicts a block diagram of the following audience member processes associated with the exemplary platform 12 and streaming platform 44 in accordance with the principles of the present invention:
Discover digital content in customized library of the streaming platform 44 (NEW, VALUE, TRENDING);
Watch digital content;
Respond to the process of verifying the sentient vision of the content;
Receive payment from the seller for providing reviews of the seller's digital content.

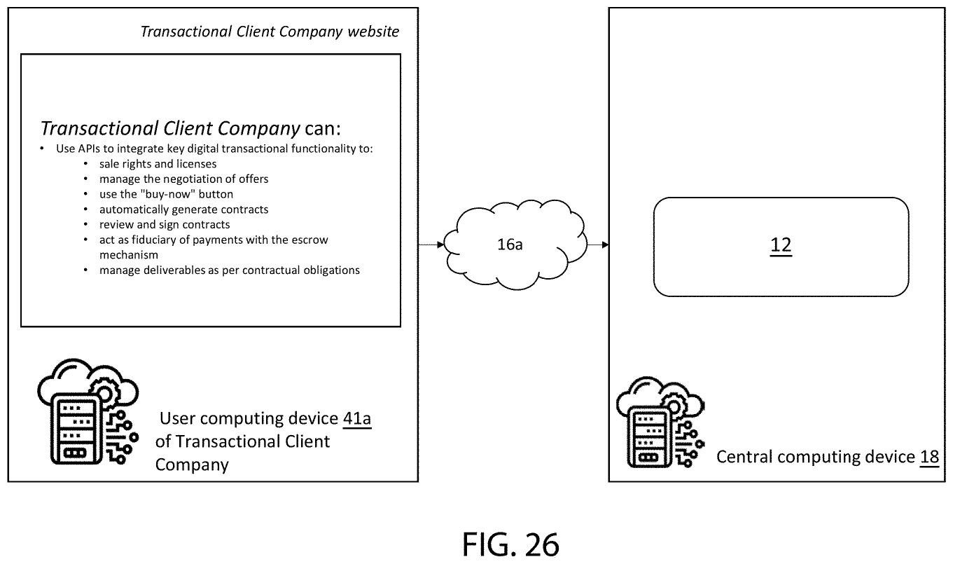

FIG. 26 depicts a block diagram of the following Transactional Client Company processes associated with the exemplary platform 12 in accordance with the principles of the present invention:
Use APIs to integrate key digital transactional functionality to:
   sale rights and licenses;
   manage the negotiation of offers
   use the “buy-now” button or other similar button to initiate the purchase of digital content;
   automatically generate purchase and/or licensing contracts;
   review and sign the purchase and/or licensing contracts;
   act as fiduciary of payments with an escrow mechanism; and
   manage deliverables as per contractual obligations.

As described herein, the central computing device 18 provides an environment, in the form of platform 12, for sellers to upload their digital content for prospective buyers. sellers can upload their content through a guided and optimized process in which they can specify all the information necessary for a buyer to evaluate a purchase. The optimization process requires the application to integrate with data referring to the contents found by third parties, so that the data-entry part is reduced to a minimum.

For sellers who have a catalog of title numbers, even thousands, an import mechanism is available that considerably shortens the data-entry portion.

Sellers can therefore show all or part of their catalog to buyers, either by inviting them to view specific contents, through the Screeners tool, or by publishing the titles in the library, in which buyers can freely search for contents of interest to them.

Through the screeners tool, sellers can safely invite buyers to view their content. According to the seller's preferences, all access can also be protected by encryption security such as two-way authentication factor, passwords, expiring dates, DRM (Digital Right Management) mechanisms, and watermarking.

Sellers have complete control and feedback on the Screeners sent. Through a graphic dashboard and reporting systems, they can always view useful statistics on who has watched, what content and for how long. They can also disable, temporarily or permanently, the possibility for some buyers to access their content again.

Thanks to the integration with third-party systems, the license availability data is always updated, thus ensuring minimal maintenance to the projects.

For structured companies with numerous employees, the company panel is available, where the company content administrator can manage the access and tasks of individual employees. In this way it is possible for several people to work simultaneously and in synergy on the various projects of their company.

In the company panel of sellers, statistics relating to the engagement of the buyers on their content in the library and Screeners are also provided, in an aggregated manner at the company level, as well as performance values relating to the licenses sold.

Buyers have an environment totally designed for their needs. They can receive and manage invitations to view and/or above all they can search for content, through powerful search filters, which uniquely integrate data that would otherwise be difficult to access in a usable and aggregate way.

Buyers can privately express and save their ILR (Interest Level Rate) in each individual content, in order to catalog and make it easy to use the content deemed of their interest, overshadowing, at the same time, those without commercial appeal.

Buyers have at their disposal a library of content selected according to their preferences. The UI (user interface) is easy and pleasant to use. The innovative algorithms of the recommendation system can enable buyers to view new content, even of lesser notoriety, in order to streamline the search process and minimize the time lost to examine content that is not relevant to their specific purpose.

The exemplary platform 12 is the only digital platform that is able to give sellers the opportunity to provide potential buyers with the vision of their video content, of all kinds, accompanied by a complete set of data, which are amalgamated with both those provided directly by the vendor and to others automatically imported through APIs from different partner companies. All the process is protected by various security mechanisms, designed to avoid the possibility that the content could be used illegally.

Buyers have the opportunity to be invited to view by the sellers and/or to be able to choose the contents of their interest through very detailed search filters and/or to be able to view new content, recommended by the exemplary platform through innovative business intelligence mechanisms. that combine explicit and implicit user preferences, applied to market trends. In this way, in addition to having the opportunity to examine more content in a much shorter time, buyers have the opportunity to acquire quality titles, not necessarily already well known to the public, in order to give visibility also to valid products generated by independent producers. In turn, they achieve greater levels of efficiency for themself and their audiences.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification and drawings, can be used synonymously in certain instances, including, but not limited to, for example, data and information.

It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A method of providing private access to digital content stored within a digital web-based platform, the method comprising:
providing a digital web-based platform, the digital web-based platform being configured to store digital content which is accessible to one or more users;
uploading, with a computing device of a first user, digital content to the digital web-based platform;
generating, with the computing device of the first user, a link for accessing the digital content stored within the digital web-based platform, the link including a set of user permissions that grants viewing access to the digital content until at least one of:
a predetermined time interval expires; and
a predetermined number of views is reached; and
transmitting, with the computing device of the first user, the link to a computing device of a second user;
displaying, with an interface of the computing device of the second user, the link to the second user; and
wherein engaging the link directs the second user to the stored digital content, the second user being able to view the digital content until at least one of:
the predetermined time interval expires; and
the predetermined number of views of the digital content is reached.

2. The method of claim 1, wherein the stored digital content includes one or more media projects.

3. The method of claim 1, wherein the digital web-based platform is hosted by a central computing device in wireless communication with the computing device of the first user and the computing device of the second user.

4. The method of claim 3, wherein the central computing device is associated with a third user different from the first and second users.

5. The method of claim 1, wherein the computing devices of the first and second users are each one of a mobile device, tablet, laptop, or computer.

6. The method of claim 1, wherein at least one of the central computing device, the computing device of the first user, and the computing device of the second user includes processing circuitry, the processing circuitry having:
a processor; and
memory in communication with the processor.

7. The method of claim 1, further including:
providing a second platform that is in communication with the first platform;
generating, with the computing device of the first user, a link for accessing the second platform; and
transmitting the link for accessing the second platform to a computing device of a third user so that the third user can stream the stored digital content from the digital web-based platform.

8. The method of claim 1, wherein the central computing device is configured to receive a signal from the computing device of the second user to disable the link.

9. A method for assigning a payment level to one or more users reviewing digital content, the method comprising:
providing, with a central computing device, a first platform and a second platform in communication with the first platform;
uploading, from a computing device of first user, digital content to a content library of the first platform;
storing the digital content within the content library, the digital content being accessible to one or more secondary users via streaming from the second platform when in the content library;
assigning, with the central computing device, the digital content to a first content category for a predetermined time period, the digital content being assigned a first payment level when in the first content category; and
measuring and comparing, with the central computing device, a number of secondary users streaming the digital content via the second platform to a predetermined threshold.

10. The method of claim 9, wherein the predetermined threshold is a maximum of number of views allowed for the digital content.

11. The method of claim 9, further including:
transferring the digital content to a second content category if the predetermined threshold is reached within the predetermined time period, the digital content is assigned a second payment level when in the second content category; and
wherein the second payment level is less than the first payment level.

12. The method of claim 11, further including:
transferring the digital content to a third content category if the predetermined threshold is not met within the predetermined time period, the digital content is assigned a third payment level when in the third content category; and
wherein the third payment level is greater than the first payment level.

13. The method of claim 12, further including:
measuring and comparing a number of secondary users viewing the digital content in the third category to the predetermined threshold;

14. The method of claim 13, further including:
transferring the digital content to a fourth category if the predetermined threshold is not met within a second predetermined time period, the digital content is assigned a fourth payment level when in the fourth content category; and
wherein the fourth payment level is greater than the third payment level.

15. The method of claim 9, wherein the central computing device is configured to receive qualitative feedback from a user computing device associated with each of the one or more secondary users.

16. The method of claim 15, wherein the qualitative feedback includes at least one of a user generated numerical score and written feedback.

17. The method of claim 9, wherein the content library is accessible to a third user different from the first user and the one or more secondary users.

18. The method of claim 17, wherein the one or more secondary users and the third user each have a computing device configured to be in communication with the central computing device so that each user can access at least one of the first platform and the second platform.

19. The method of claim 18, further including:
generating an invitation link to access the stored digital content; and
providing the invitation link to the third user to access the stored digital content.

20. A digital web-based platform system, comprising:
a central computing device having processing circuitry configured to host a first platform and a second platform in communication with the first platform;
a plurality of user computing devices, at least one of the plurality of user computing devices being in communication with the first platform via a web-based connection and at least one of the plurality of user computing devices being in communication with the second platform;
at least one other computing device being in communication with the first platform via an Application Programming Interface (API) connection; and
wherein:
the first platform includes one or more microservices each associated with a predetermined system operation;
the second platform includes a content library configured to store digital content uploaded from at least one of the plurality of user computing devices for streaming to another user computing device; and
the first platform and the second platform each utilize the processing circuitry of the central computing device to store digital content uploaded by a user.
